(19) United States
(12) Patent Application Publication
(10) Pub. No.: US 2008/0220982 A1
(43) Pub. Date: Sep. 11, 2008

(54) Nanoparticle Probes for Capture, Sorting and Placement of Targets

(76) Inventor: Tania Q. Vu, Beaverton, OR (US)

Correspondence Address: KLARQUIST SPARKMAN, LLP, 121 SW SALMON STREET, SUITE 1600, PORTLAND, OR, 97204, US

(21) Appl. No.: 11/996,518

(22) PCT Filed: Jul. 25, 2006
(86) PCT No.: PCT/US06/29018

§ 371 Date: Jan. 23, 2008

Related U.S. Application Data
(60) Provisional application No. 60/702,789, filed on Jul. 26, 2005.

(51) Int. Cl. C40B 30/04; C40B 40/00; C40B 40/10; C40B 50/14; C40B 60/12

(52) U.S. Cl. 506/9; 506/13; 506/18; 506/39; 506/30

(57) ABSTRACT

A nanoparticle probe is attached to a substrate to capture targets. The nanoparticle probe includes a specific binding agent that specifically binds to a target biomolecule. The biomolecule can be associated with a cell, for example expressed on the cell's surface, such that the cell is bound to the probe immobilized on the substrate. The nanoparticle probes can be applied to the substrate in a layer, for example in the form of a spot, and multiple spots can be applied to the substrate to form patterns or arrays of the spots on the substrate. The nanoparticle probe presents a binding surface on which oriented specific binding agents (such as antibodies or nucleic acids) can be attached. In particular examples the nanoparticle is spaced slightly from the substrate, for example by a linker, to provide a probe with improved contact with a liquid in which target biomolecules or cells are suspended. The probes can be applied to the substrate in identifiable locations, either by applying the nanoparticle probes to the substrate at a predetermined address or using a nanoparticle probe that emits a signal to identify its location. Particular examples of such probes are semiconductor nanocrystals such as quantum dots, which emit fluorescence of a particular color. The nanoparticle probes can sort biomolecules or cells of different types or subtypes, and maintain them in a substantially fixed location on the substrate where they can be studied for prolonged periods of time.

### CROSS REFERENCE TO RELATED APPLICATION

Priority is claimed to U.S. Provisional Application No. 60/702,789, filed Jul. 26, 2005, the disclosure of which is incorporated herein in its entirety for all purposes.

### FIELD

This invention concerns arrays of nanoparticle probes, such as quantum dot probes, that are useful for capture, sorting and placement of biological targets, such as proteins and cells.

### BACKGROUND

Microscopic identification and separation of low-abundance protein markers or populations of target cells can be performed manually, but such techniques are time consuming, tedious and prone to error. Therefore, high-throughput screening, capture, and sorting of biomolecules or cells in complex bio-fluid specimens is preferable. Current screens for rare biomarkers such as ELISA-based assays are limited by detection sensitivity and low signal to noise. Moreover, parallel detection of multiple markers is not typically possible using ELISA. In the case of detection of specific types of cells, flow cytometry permits automated separation of cells, but individual cells separated in this manner can only be observed once. Flow cytometry does not permit long term analysis of the same cell, and can be damaging to cells. Electrostatic and mechanical sorting devices, as well as laser capture micro-dissection, have also permitted populations of target cells to be identified and separated for study and are effective at separating cells with large differences in physiochemical differences (size, density). However, these techniques are not effective in differentiating between cells with similar physical properties (for examples subtypes of similar cells, such as subtypes of most neuronal cells).

Advances in microsystems technology have provided many additional sorting techniques by scaling devices down to the micron level. Microelectromechanical (MEMS) systems have been developed, for example, in which arrays of wells are etched into silicon to passively capture cells by gravitational settling (as described in U.S. Pat. No. 6,692,952). Other cellular purification and sorting techniques include enzymatic treatments, fluorescent activated sorting, and immunopanning.

In spite of recent advances, current cell separation techniques often suffer from low sensitivity that results in low yield or purity (as with enzymatic treatment, selective toxins, fluorescent activated sorting), are limited to a few specific cell types (as in immunopanning), or do not allow for longer term cellular analysis. It would also be helpful to develop a cell sorting method that did not require the use of fluorescent dyes, because those dyes bleach quickly, are toxic to cells, or have to be applied to cells after the cell is killed and fixed.

It would also be advantageous to provide a method of efficiently capturing and sorting large numbers of particular live target cells, such as sub-types of neuronal cells. This separation would permit live cells to be dynamically interrogated over extended periods of time (such as minutes, days or months) in long term culture. Methods of separating live cells would also allow them to be studied in isolation from each other, for example to distinguish the effect of a toxin or drug on a target cell from the effect of neighboring cells on the target cell. Alternatively it would be helpful to be able to position different target cells in a stable relationship to one another to study cellular communication.

### SUMMARY

The present disclosure concerns nanoparticle arrays for the detection of target biomolecules, including biomolecules expressed by cells. The arrays include a plurality of identifiable nanoparticle probes attached to a substrate. The identifiable nanoparticle probes include at least one specific binding molecule for binding to a target molecule, such as a target biomolecule on a cell or in a complex mixture, such as a cellular homogenate. The identifiable nanoparticle probes provide an indication of the identity of the specific binding molecule. In certain examples, the nanoparticle probes are semiconductor crystal nanospheres. Additional features of this disclosure include methods for making and using the nanoparticle arrays.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic drawing of a series of steps in a soft photolithography process for applying the nanoparticle probes to a substrate in an ordered array.

FIG. 2 is a schematic view of a nanoparticle probe applied to a glass substrate through a strepavidin biotin linker. Illustration is not drawn to scale.

FIG. 3 is a schematic view of a nanoparticle probe applied to a glass substrate through a biotinylated anti-collagen antibody that binds to a collagen coated substrate. Illustration is not drawn to scale.

FIG. 4 is a schematic view of nanoparticle probes attached to a substrate for sorting cells to addresses on the substrate that have a binding affinity for an antigen on the cells. Illustration is not drawn to scale.

FIGS. 5A-D are a series of images that illustrate in a cross-section of the raised application surface on the stamp for applying the nanoparticle probes (FIG. 5A); and nanoparticle probes applied to substrates using the stamp (FIGS. 5B, 5C and 5D). FIG. 5B) Bright field image of High Density QD Array. FIG. 5C) Fluorescence image of low density QD array. FIG. 5D) Fluorescence Image of high density QD Arrays at 10 nM.

FIGS. 6A-C are a series of images that illustrate monolayers of quantum dots printed on glass slides. 6A) Fluorescent image. 6B) AFM top view. 6C) AFM surface topology.

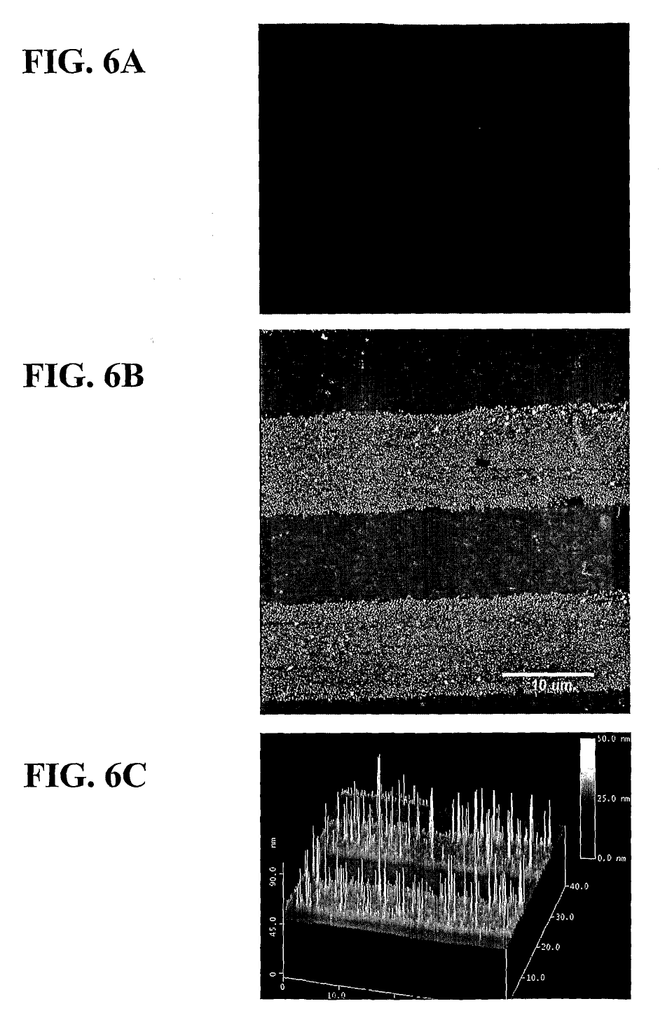

FIG. 7 is an image of an AFM height profile that shows printed quantum dot arrays are composed of monolayered quantum dots.

FIGS. 8A-C are a series of images that illustrate capture and binding of freely soluble individual biotin-quantum dots with printed streptavidin-quantum dots. 8A) Printed streptavidin-QDs. 8B) Captured biotin-QDs. 8C) Overlay.

### DETAILED DESCRIPTION

This disclosure concerns arrays of nanoparticle probes capable of binding to biological targets, such as biological molecules and cells. In the disclosed arrays, nanoparticle probes that include specific binding agents (such as antibodies) are positioned at addressable locations on a substrate. The small, oriented surfaces of nanoparticles (such as nanospheres, for example semiconductor nanocrystals or “quantum dots”) present a three dimensional display of the binding agents for efficient binding of targets. Moreover, the nanoparticles can be spaced from a substrate surface (for example by a flexible linker) to provide for highly effective interaction of the nanoparticle probes with target biomolecules (including cellular targets). Such devices are capable of separating biomolecules from complex mixtures, such as cellular lysates or homogenates, and ex vivo capturing and sorting of live target cells (such as neuronal cells) or particular target subpopulations of cells (such as neuronal cells that express a GABA receptor or rhodopsin), and retaining them in an identifiable position for a sustained period of time (such as days, weeks or months) so that they can be studied and dynamically interrogated over that period of time. For example, cells can be retained in an array to be observed over periods of time, and their responses to exogenous agents (such as drugs or toxins) determined. Alternatively, different target cell populations can be arranged on the substrate in preselected relationships to study cellular interactions of living cells.

The disclosed arrays take advantage of the ability of nanoparticles to provide oriented nanoscale surfaces that serve as a substrate to present a high density of specific binding agents, such as antibodies. The oriented high density binding agents are therefore designed to bind biomolecules and cells with high affinity and immobilize them on a substrate. In embodiments in which the nanoparticle is a semiconductor nanocrystal such as a quantum dot, the quantum dot is activated (for example by illuminating it with light of a selected frequency and/or intensity) to induce fluorescence of the quantum dot to identify or localize the bound molecules or cells on the substrate. The nanoparticles can act as probes arrayed in groups (for example in a square or circular spot) of a desired nanoparticle density at discrete locations on the substrate. Different groups of nanoparticle probes on the array can bind the same target, or different groups of nanoparticle probes can bind different targets. In particularly disclosed examples, the target is a cell that expresses an antigen that is recognized and bound by the antibodies to bind the cell to the probe and substrate at the identifiable location.

Certain disclosed examples of the device include a substrate and a plurality of nanoparticle probes attached to the substrate (for example in addressable locations) so that the nanoparticle probes present the specific binding molecules for binding a target biomolecule such as an antigen (or a cell associated with the antigen). The addressable locations can be identified, for example, by an identifiable nanoparticle probe that provides an indication of the identity of the specific binding molecule associated with that nanoparticle probe. Such nanoparticle probes can be referred to as self-identifiable nanoparticle probes. In examples in which the identifiable nanoparticle probes are quantum dots, the semiconductor nanocrystals emit detectable electromagnetic signals (such as colors of light or electromagnetic bar codes) that provide the indication of the identity of the specific binding molecule bound to the quantum dot. Hence the binding target of the antibody bound to the quantum dot can be determined by the signal emitted by the quantum dot.

In some disclosed examples, the array is capable of collecting and sorting targets, such as molecular (biomolecular) or cellular targets, and then selectively releasing the biomolecules or cells (or subsets of the cells). For example, the nanoparticles are attached to the substrate with a cleavable bond that can be selectively cleaved in response to a trigger event, such as exposure of the bond to ultraviolet light.

In these and other particular embodiments, the nanoparticles are attached to the substrate by an attachment moiety, such as an antibody, and the specific binding molecule comprises a targeting antibody that binds the target biomolecule with high affinity.

In one example, the device includes a substrate to which a plurality of semiconductor nanocrystal (e.g., semiconductor nanosphere) probes are attached, and the semiconductor nanocrystals have a characteristic fluorescence that identifies a location of the probes on the substrate. Antibodies are attached to the surfaces of the probes for binding a specific target biomolecule to the probe. The semiconductor nanocrystal probes can be present in a layer on the substrate, and in a density of probes that mimics a concentration of epitopes (such as receptors) on a cell surface. In particular examples, the semiconductor nanocrystal probes are present in a layer (such as a monolayer) applied to the surface from a solution containing 20-40 nM of the semiconductor nanocrystals. In other examples, the density of the nanospheres can reach packing densities of up to 10,0000 probes/μm², for example at least 1,000 or 5,000 or 7,500 probes/μm².

In particular examples of the device, the nanoparticles are attached to the substrate by an antibody that binds both the nanoparticle and the substrate. For instance, the substrate can include a layer of collagen, and the antibody that binds the substrate is a biotinylated anti-collagen antibody. Streptavidin is bound to the nanoparticle such that the streptavidin is bound by the biotinylated antibody that binds the collagen of the substrate. In this manner the nanoparticle is securely attached to a specific addressable location on the substrate, such that the antibodies on the nanoparticle probes bind the target biomolecule in a fixed location on the substrate.

The present disclosure also describes methods of selectively binding biological targets to the substrate, by exposing the device to a biological sample (such as a cellular suspension, homogenate or lysate) so that target biomolecules that can be present in the sample bind to the specific binding molecule on the nanoparticle probes (or to the specific binding molecules on a confluent grouping of nanoparticles in a defined region on the substrate). The bound target biomolecules (or in turn any cells associated with the target biomolecules) can be localized by the characteristic fluorescence emitted by the nanoparticle following exposure of the nanoparticle to a stimulus, such as electromagnetic radiation that induces emission of the characteristic fluorescence from the nanoparticle. In some examples, the characteristic fluorescence is light of a particular color (such as red or green light).

A particular advantage of some of the disclosed methods is that multiple biomolecules or cells can be bound to the plurality of nanoparticle probes to collect a target population. The plurality of nanoparticles can be present, for example, in a substantially confluent layer in a discrete region (such as a square area) on the substrate. Multiple such discrete regions can be present on the substrate, and the binding specificity of the regions can be the same or different. In some examples the collected biomolecules or cells can be selectively released from the substrate for subsequent collection and/or additional study. In such examples the nanoparticles are attached to the substrate by linkers that are selectively lysable, and the linkers are lysed to release the bound nanosphere probes and their attached labeled cells.

This disclosure also provides methods of making the device using soft photolithography techniques. The substrate can be formed, for example, by applying the nanoparticles to the surface of a template having raised application surfaces that correspond to areas of the substrate to which the nanoparticles are to be applied. The template is then placed against the substrate to transfer the nanoparticles to the substrate in a pattern that corresponds to the raised application surfaces on the template. The transferred nanoparticles can in this manner be applied in an ordered array of spots on the surface of the substrate, with the nanoparticles applied in areas of sufficient density to correspond to epitopes on the surfaces of targets. In some examples the surface of the substrate is functionalized prior to applying the template to the substrate to improve adherence of the nanoparticles to the substrate.

This detailed description provides examples of a new approach for capturing and sorting population of cells using nanoparticle probes, such as quantum dots, as capture surfaces. Many different types and shapes of nanoparticles can be used as probes, but nanospheres such as quantum dots that have smooth uniform surfaces very readily permit the uniform attachment of one or more antibodies to the surface of the particle. The nanoparticle probes in some of these examples are attached to a substrate by a linker that spaces the nanoparticle from the substrate surface and provides an orientation surface on which one or more targeting antibodies can be bound. The nanoparticle therefore provides an oriented and substantially uniform surface, spaced from the substrate surface, which is ideal for binding target epitopes such as surface antigens of cells. The nanoparticle probes can be provided in substantially confluent monolayers in defined areas (such as small squares) on the substrate, and the defined areas themselves can also form a two-dimensional array displayed on the substrate surface. If the nanoparticle is a quantum dot which fluoresces with a characteristic signal (such as a color), that characteristic signal can be used to identify the specificity of antibodies on the surface of the quantum dots, and in turn can locate and/or identify target cells bound to the substrate.

### Terms

Unless otherwise explained, all technical and scientific terms used herein have the same meaning as commonly understood by one of ordinary skill in the art to which this disclosure belongs. Definitions of common terms in molecular biology can be found in Benjamin Lewin, Genes V, published by Oxford University Press, 1994 (ISBN 0-19-854287-9); Kendrew et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8).

The singular terms “a,” “an,” and “the” include plural referents unless context clearly indicates otherwise. Similarly, the word “or” is intended to include “and” unless the context clearly indicates otherwise. It is further to be understood that all base sizes or amino acid sizes, and all molecular weight or molecular mass values, given for nucleic acids or polypeptides are approximate, and are provided for description. Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

In order to facilitate review of the various embodiments of this disclosure, the following explanations of specific terms are provided:

Array: An arrangement of molecules, for example nanoparticle probes, in addressable locations on a substrate. The array can be regular (arranged in uniform rows and columns, for instance) or irregular. The number of addressable locations on the array can vary, for example from a few (such as three) to more than 50, 100, 200, 500, 1000, 10,000, or more. A “microarray” is an array that is miniaturized so as to require or benefit from microscopic examination, or other magnification, for its evaluation. Further miniaturization can be used to produce “nanoarrays.”

Within an array, each arrayed probe is addressable, in that its location can be reliably and consistently determined within the at least two dimensions of the array surface. In ordered arrays, the location of each probe can be assigned at the time when it is spotted or otherwise applied onto the array surface, and a key can be provided in order to correlate each location with the appropriate target. Often, ordered arrays are arranged in a symmetrical grid pattern, but samples could be arranged in other patterns (e.g., in radially distributed lines, spiral lines, or ordered clusters). Addressable probe arrays can be computer readable, in that a computer can be programmed to correlate a particular address on the array with information (such as hybridization or binding data, including for instance signal intensity). In some examples of computer readable formats, the individual “spots” on the array surface will be arranged regularly in a pattern (e.g., a Cartesian grid pattern) that can be correlated to address information by a computer.

The sample application “spot” on an array can assume many different shapes. Thus, though the term “spot” is used, it refers generally to a localized deposit of nanoparticle probes, and is not limited to a round or substantially round region. For instance, substantially square regions of mixture application can be used with arrays encompassed herein, as can be regions that are substantially rectangular (such as a slot blot-type application), or triangular, oval, or irregular. The shape of the array substrate itself is also immaterial, though it is usually substantially flat and can be rectangular or square in general shape.

cDNA (complementary DNA): A piece of DNA lacking internal, non-coding segments (introns) and transcriptional regulatory sequences. cDNA can also contain untranslated regions (UTRs) that are responsible for translational control in the corresponding RNA molecule. cDNA is usually synthesized in the laboratory by reverse transcription from messenger RNA extracted from cells or other samples.

Feature: An addressable spot/element. Features can be created by printing the probes, usually within some type of matrix, onto the array platform by a printing device, such as a quill like pen, a template stamp, or by a touch-less deposition system (see, e.g., Harris et al., Nature Biotech. 18:384-385, 2000).

Linker: A compound or moiety that acts as a molecular bridge to operably link two different molecules, wherein one portion of the linker is operably linked to a first molecule, and wherein another portion of the linker is operably linked to a second molecule. The two different molecules can be linked to the linker in a step-wise manner. There are no particular size or content limitations for the linker so long as it can fulfill its purpose as a molecular bridge. Linkers are known to those skilled in the art to include, but are not limited to, chemical chains, chemical compounds, carbohydrate chains, peptides, haptens, and the like. The linkers can include, but are not limited to, homobifunctional linkers and heterobifunctional linkers. Heterobifunctional linkers, well known to those skilled in the art, contain one end having a first reactive functionality to specifically link a first molecule, and an opposite end having a second reactive functionality to specifically link to a second molecule. Depending on such factors as the molecules to be linked, and the conditions in which the method of detection is performed, the linker can vary in length and composition for optimizing such properties as flexibility, stability, and resistance to certain chemical and/or temperature parameters. For example, short linkers of sufficient flexibility include, but are not limited to, linkers having from 2 to 10 carbon atoms (see for example U.S. Pat. No. 5,817,795).

In certain examples the linkers are selectively lysable, for example by photoactivation, such as by exposure to ultraviolet radiation. Such linkers are known in the art, for example a UV cleavable linker sold by Glen Research of Sterling, Va. as a PC Biotin photocleavable linker. Photocleavable linkers such as a PC Amino-Modifier Phosporamidite linker can couple a nanoparticle probe to a substrate and be subsequently cleaved to release a the nanoparticle probe from that surface to selectively release cells bound to these nanoparticle probes.

Nanoparticles: Particles having at least one maximum dimension of 100 nm. An example of a nanoparticle is a quantum dot, but other examples include iron oxide or gold nanoparticles. Examples of methods of making gold nanoparticles are disclosed in U.S. Patent Publication 2005/0120174. Nanoparticles used as the nanoparticle probes of the present disclosure can be of any shape (such a spherical, tubular, pyramidal, conical or cubical), but particularly suitable nanoparticles are spherical. The spherical surface provides a substantially smooth and predictable high surface to volume ration that can be optimized for controlled attachment of specific binding agents such as antibodies, with the bound agents extending substantially radially outwardly from the surface of the sphere.

Probe: Any molecule that specifically binds to a protein or nucleic acid sequence that is being targeted, and which can be identified so that the targets can then be detected. In particular examples, the probe is a nanoparticle probe that is labeled with a specific binding agent for binding the nanoparticle to a target, such as a particular protein or type of sub-type of a cell. In certain embodiments, the probe can be identified by the color or composition of the nanoparticle, or by a color of light emitted by the nanoparticle (as in a quantum dot).

Sample: Any quantity of a substance that includes targets that can be used in a method disclosed herein. The sample can be a biological sample or can be extracted from a biological sample derived from humans, animals, plants, fungi, yeast, bacteria, tissue cultures, viral cultures, or combinations thereof. In particular examples of the disclosed nanoparticle probe device and method, the biological sample is a cellular suspension. The cellular suspension can include cells of different histological types (such as cells from lung, gastrointestinal tract, brain, and heart), or cells of a single histological type (such as neurons).

Semiconductor nanocrystals or quantum dots: Semiconductor nanocrystals (or semiconductor nanocrystals) have evolved over the last few years to provide a new type of fluorescent label. Semiconductor crystalline nanospheres are also known as quantum dots, which are engineered, inorganic, semiconductor nanocrystals that fluoresce stably and possess a uniform spherical surface area that can be chemically modified to attach biomolecules to them. Generally, quantum dots can be prepared with relative monodispersity (for example, with the diameter of the core varying approximately less than 10% between quantum dots in the preparation), as has been described previously (Bawendi et al., 1993, J. Am. Chem. Soc. 115:8706). Quantum dots are known in the art have, for example, a core selected from the group consisting of CdSe, CdS, and CdTe (collectively referred to as “CdX”). These quantum dots have been used in place of organic fluorescent dyes as labels in immunoassays (as in U.S. Pat. No. 6,306,610) and as molecular beacons in nucleic acid assays (as in U.S. Pat. No. 6,500,622).

Specific binding molecule: A specific binding molecule (or agent) is an agent that binds substantially only to a defined target. Thus a protein-specific binding molecule binds substantially only the specified protein. Examples include antibodies that bind to specific antigens, and nucleic acid molecules that hybridize to substantially identical complementary nucleic acid sequences under hybridization conditions of varying stringency (such as highly stringent conditions). Another example is a protein that specifically binds to a receptor (such as neurotrophin that specifically binds to a TrkA receptor expressed on the surface of certain neurons).

Substrate: The substrates to which the nanoparticle probes are attached can be any surface capable of having the nanoparticle probes bound thereto. Such surfaces include, without limitation, glass, metal, plastic or materials coated with a functional group designed to enhance binding of the nanoparticle probes to the substrate. The substrates can be of any suitable size and thickness, and they can be adapted for placement in culture vessels for maintaining cell viability for prolonged or other desired periods of time while cells are bound to the substrate. Flat surfaces are particular useful substrates.

Sub-type of cell: A subcategory of target cells of interest. For example, cells of different sub-types can be those of different types of tissue in the body, such as neurons, myocardial cells, skeletal muscle, lung or colon. Alternatively, sub-types are cells of a same tissue having different phenotypes (such as neurons that either do or do not express GABA receptors, or colon cells of different specializations such as epithelial cells or sub-epithelial cells). The distinction between a type and sub-type is only meant to reflect a further categorization of a genus of cells, which can be arbitrary or widely recognized in the field.

Target: A target for the nanoparticle probes is a molecule or other biological structure (such as a cell) of interest, such as a molecule or cell that is to be captured and/or isolated and studied. Examples of such targets include particular epitopes, antigens, or cells, such as cells displaying a particular antigen on its surface. Examples of such cells include neural cells, or a subpopulation of a neural cell such as those expressing a GABA cell surface receptor or rhodopsin that can be recognized and bound by a specific binding agent.

The nanoparticle probes will be better understood by reference to the following Description and Examples, which are intended to illustrate but not limit the invention.

### Introduction

There is a great need for techniques to establish well-defined, substantially pure cultures of cells, such as neuronal cells. Selecting and sorting such cells is useful for isolating specific components of cell populations (such as organs and tissues, including neural tissue) and understanding the phenotype and function of select subtypes of cells underlying normal and pathological (e.g., neuropathological) conditions. Similarly, there is a need for isolating biomolecules, such as biological macromolecules from complex mixtures, such as cellular lysates and homogenates. The nanoparticle probe arrays disclosed herein provide a system for the identification, collection and analysis of biomolecules from complex mixtures of biomolecules, and for the identification, collection and analysis of cells from diverse populations of cells, including both prokaryotic and eukaryotic cells. These arrays can be utilized in the sorting and/or analysis of essentially any target biomolecule, so long as a specific binding agent is available (or producible) that binds to the target biomolecule. Similarly, these arrays can be used in the sorting and collection of essentially any target cell expressing a biomolecule, so long as a specific binding molecule for the biomolecule expressed by the target cell is available (or producible). Thus, although the arrays can be designed and used to identify and collect biomolecules and cells of diverse origins, specific examples of methods of using the disclosed arrays are provided with respect to the analysis of neuronal biomolecules and tissues, which have previously proven particularly challenging to isolate, collect (for example, sort) and analysis in vitro.

For example, nanoparticle probe arrays can be used as platforms for sorting and capture of living neuronal cells in a manner that preserves their viability for prolonged study. Many different types of nanoparticles (such as iron oxide, gold nanoparticles, fluorescently-doped nanoparticles and semiconductor nanocrystal nanoparticle, e.g., quantum dots) can be used to array the specific capture agents on a substrate with an orientation spaced from and extending outwardly (for example radially outwardly) from the particle to which it is attached. In one specific embodiment, the nanoparticle is a semiconductor nanocrystalline nanosphere or quantum dot.

Quantum dot probes form a biocompatible surface that provides well-defined spatial positioning and easy identification of captured neuronal subtypes. The quantum dot probe is able to capture selected subtypes of cells (such as subtypes of neurons) with high sensitivity and specificity. The quantum dot probes in this example are on a size scale that is much smaller (1-100 nm) than that of a cell (10 μm), which enables improvements in sensitivity at low cost. In addition, quantum dots can be produced at a size (6-8 nm) that is well-matched to the density of target cell-receptors. Quantum dots also exhibit intrinsic fluorescence that makes them convenient for long term non-invasive identification of multiple neuron populations that are bound to the nanoparticle probes on a substrate.

When stimulated with broad-band excitation these particles exhibit extended photostability. The stable fluorescent emission of quantum dots, unlike traditional organic dyes (such as rhodamine or FITC), has allowed free colloidal suspensions of quantum dots to be used to successfully attach and bind specific proteins to cells, and to identify and label proteins and cells living months after QD attachment without significant bleaching (Chan et al., Quantum dot bioconjugates for ultrasensitive nonisotopic detection, Science, 1998. 281: 2016-8). The simultaneous multicolor identification of quantum dots permits rapid identification of probes without requiring fixation of the cells. Additionally, the color of light emitted can be tuned based on size of the nanoparticle. This feature permits creation of a single substrate array with quantum dots that fluoresce one color to target, select and capture a particular type of cell for in vitro study, and with quantum dots that fluoresce another color to likewise capture a different type of target cell onto the same platform.

The surface-controllable properties of quantum dots permit chemical modification of quantum dots for immobilization to macrosubstrates (such as slides or chips) as well as for attachment of biomolecules to the quantum dot surface. By selecting appropriate binding reagents that are specific for biomolecules of interest, for example neuronal cell markers, the nanoparticle arrays can be used to identify and purify or analyze therapeutically useful and scientifically important neural cells populations. Quantum dots, like other nanoparticles, can be immobilized with high-packing density onto surfaces and packed with capture antibodies that match well the density of target surface neuronal antigens. For example, examples, the density of nanoparticles, such as quantum dots can reach packing densities of up to 10,0000 nanoparticle probes/μm², for example at least 1,000 or 5,000 or 7,500 probes/μm².

The quantum dot platforms permit long-term optical identification of captured viable cells. The versatility of nanoparticles such as quantum dots also permits spatial printing of the nanoparticles onto the platform surface with precise spatial positioning. By arranging two or more groups of nanoparticles (each of which is identifiable by the color of light emitted) with different target biomolecule binding-agent in a selected pattern, the precise spatial positioning of two different populations of cells at micron resolution accompanied by ready identification of the cells can be accomplished. Thus, selected subtypes of neurons can be attached to the same substrate in specified positions, such that the interactions between the neuronal subtypes can be manipulated and evaluated in vitro over an extended period of time. In other embodiments, the populations of cells can be provided in arrays that permit high-throughput and biosensor analysis for rare event detection.

### Nanoparticle Probes

One aspect of the present disclosure relates to nanoparticle probes that include a specific binding agent for detecting (e.g., identifying, capturing, sorting, etc.) a biomolecule (or cell expressing a biomolecule) of interest. Nanoparticles are discrete structures having at least one dimension less than or equal to 100 nm (for example, less than 50 nm, for example 0.1 nm-100 nm, such as 1-100 nm, 1-50 nm or 1-10 nm). Typically a nanoparticle has three dimensions on the nanoscale. That is, the particle is between 0.1 and 100 nm in each spatial dimension.

An example of a nanoparticle is a quantum dot, but other examples include various polymers, silica (including dye-doped silica), and metal oxides and metals, such as iron oxide and gold nanoparticles. Examples of methods of making gold nanoparticles are disclosed in U.S. Patent Publication 2005/0120174. Nanoparticles used as the nanoparticle probes of the present disclosure can be of any shape (such a spherical, tubular, pyramidal, conical or cubical), but particularly suitable nanoparticles are spherical. The spherical surface provides a substantially smooth and predictably oriented surface for the attachment of specific binding agents such as antibodies, with the attached agents extending substantially radially outwardly from the surface of the sphere.

In particular embodiments the nanoparticle is spaced from a substrate by a linker, and/or the targeting antibodies are linked to the nanoparticle by linkers that space the binding agent slightly from the nanoparticle. As a result, multiple antibodies are distributed over the surface of the nanoparticle to form a three dimensional binding surface that efficiently interacts with epitopes on targets, such as cell surfaces. In addition, multiple such nanoparticle can be arranged in a layer (such as a monolayer) to provide a particularly high density of oriented antibodies for binding targets. The monolayers can be applied to the substrate in a discrete capture area (such as a spot) or multiple such capture area (spots) over the surface of the substrate. Such spots can in turn form a two-dimensional matrix of addressable spots. The spots are addressable, for example by their location or by a signal provided by the spot, such as a fluorescent signal (for example a color of light) emitted by the nanoparticle in the spot.

### Semiconductor Nanocrystals

In certain embodiments, the identifiable nanoparticles are semiconductor nanocrystals, also known as quantum dots (e.g., QUANTUM DOTS™). Semiconductor nanocrystals are nanoparticles having size-dependent optical and/or electrical properties. When semiconductor nanocrystals are illuminated with a primary energy source, a secondary emission of energy occurs of a frequency that corresponds to the bandgap of the semiconductor material used in the semiconductor nanocrystal. In quantum confined particles, the bandgap energy is a function of the size and/or composition of the nanocrystal. As the band gap energy of such semiconductor nanocrystals varies with size, coating and/or material of the crystal, populations of these crystals can be produced that have a variety of spectral emission properties. Furthermore, the intensity of the emission of a particular wavelength can be varied, thereby enabling the use of a variety of encoding schemes. A spectral label defined by a combination of semiconductor nanocrystals with differing emission signals can be identified from the characteristics of the spectrum emitted by the label when the semiconductor nanocrystals are energized. Semiconductor nanocrystals with different spectral characteristics are described in e.g., U.S. Pat. No. 6,602,671, which is incorporated herein by reference.

A mixed population of semiconductor nanocrystals of various sizes and/or compositions can be excited simultaneously using a single wavelength of light and the detectable luminescence can be engineered to occur at a plurality of wavelengths. The luminescent emission is related to the size and/or the composition of the constituent semiconductor nanocrystals of the population. Furthermore, semiconductor nanocrystals can be made highly luminescent through the use of a shell material which efficiently encapsulates the surface of the semiconductor nanocrystal core. A “core/shell” semiconductor nanocrystal has a high quantum efficiency and significantly improved photochemical stability. The surface of the core/shell semiconductor nanocrystal can be modified to produce semiconductor nanocrystals that can be coupled to a variety of biological molecules or substrates by techniques described in, for example, Bruchez et. al. (1998) Science 281:2013-2016, Chan et. al. (1998) Science 281:2016-2018, and U.S. Pat. No. 6,274,323, which are incorporated herein by reference.

Semiconductor nanocrystals can be used to detect or track a single target, such as a biomolecule (e.g., a biomolecule expressed by a cell). Additionally, a mixed population of semiconductor nanocrystals can be used for either simultaneous detection of multiple targets (e.g., cells) or to detect particular biomolecules and/or other items of interest, such as cells, in, e.g., a population of cells, such as cultured cells, suspensions of primary cells, disaggregated tissues or organs. As described herein, the semiconductor nanocrystals can be used to detect particular cells or components of a mixed population of cells in the context of an array, as described in greater detail below.

For example, compositions of semiconductor nanocrystals comprising one or more particle size distributions having characteristic spectral emissions can be used to either identify particular cells of interest. The semiconductor nanocrystals can be tuned to a desired wavelength to produce a characteristic spectral emission by changing the composition and size, or size distribution, of the semiconductor nanocrystal. The information encoded by the semiconductor nanocrystals can be spectroscopically decoded, thus providing the location and/or identity of the particular item or component of interest.

Semiconductor nanocrystals for use in the subject methods are made using techniques known in the art. Examples of semiconductor nanocrystals suitable for use in the arrays and methods disclosed herein are available commercially, for example, from Invitrogen (Carlsbad, Calif.) and Evident Technologies (Troy, N.Y.). Semiconductor nanocrystals useful in the practice of the invention include nanocrystals of Group II-VI semiconductors such as MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, and HgTe as well as mixed compositions thereof; as well as nanocrystals of Group III-V semiconductors such as GaAs, InGaAs, InP, and InAs and mixed compositions thereof. The use of Group IV semiconductors such as germanium or silicon, or the use of organic semiconductors, can also be feasible under certain conditions. The semiconductor nanocrystals can also include alloys comprising two or more semiconductors selected from the group consisting of the above Group III-V compounds, Group II-VI compounds, Group IV elements, and combinations of same.

Formation of semiconductor nanocrystals of various compositions are disclosed in, e.g., U.S. Pat. Nos. 6,927,069, 6,855,202, 6,689,338, 6,306,736, 6,225,198, 6,207,392, 6,048,616; 5,990,479; 5,690,807; 5,571,018; 5,505,928; 5,262,357 (all of which are incorporated herein in their entireties); as well as PCT Publication No. 99/26299 (published May 27, 1999).

The semiconductor nanocrystals described herein have a capability of absorbing radiation over a broad wavelength band. This wavelength band includes the range from gamma radiation to microwave radiation. In addition, these semiconductor nanocrystals have a capability of emitting radiation within a narrow wavelength band of about 40 nm or less, preferably about 20 nm or less, thus permitting the simultaneous use of a plurality of differently colored semiconductor nanocrystal probes without overlap (or with a small amount of overlap) in wavelengths of emitted light when exposed to the same energy source. Both the absorption and emission properties of semiconductor nanocrystals can serve as advantages over dye molecules which have narrow wavelength bands of absorption (e.g. about 30-50 nm) and broad wavelength bands of emission (e.g. about 100 nm) and broad tails of emission (e.g. another 100 nm) on the red side of the spectrum. Both of these properties of dyes impair the ability to use a plurality of differently colored dyes when exposed to the same energy source.

The frequency or wavelength of the narrow wavelength band of light emitted from the semiconductor nanocrystal can be further selected according to the physical properties of the semiconductor nanocrystal. There are many alternatives to selectively manipulate the emission wavelength of semiconductor nanocrystals. These alternatives include: (1) varying the composition of the nanocrystal, and (2) adding a plurality of shells around the core of the nanocrystal in the form of concentric shells. Thus, as one of ordinary skill in the art will realize, a particular composition of a semiconductor nanocrystal as listed above will be selected based upon the spectral region being monitored. For example, semiconductor nanocrystals that emit energy in the visible range include, but are not limited to, CdS, CdSe, CdTe, ZnSe, ZnTe, GaP, and GaAs. Semiconductor nanocrystals that emit energy in the near IR range include, but are not limited to, InP, InAs, InSb, PbS, and PbSe. Finally, semiconductor nanocrystals that emit energy in the blue to near-ultraviolet include, but are not limited to, ZnS and GaN. A nanocrystal composed of a 3 nm core of CdSe and a 2 nm thick shell of CdS will emit a narrow wavelength band of light with a peak intensity wavelength of 600 nm. In contrast, a nanocrystal composed of a 3 nm core of CdSe and a 2 nm thick shell of ZnS will emit a narrow wavelength band of light with a peak intensity wavelength of 560 nm. It should be noted that different wavelengths can also be obtained in multiple shell type semiconductor nanocrystals by respectively using different semiconductor nanocrystals in different shells, for example, by not using the same semiconductor nanocrystal in each of the plurality of concentric shells.

Additionally, the emission spectra of semiconductor nanocrystals of the same composition can be tuned by varying the size of the particle with larger particles tending to emit at longer wavelengths. For example, quantum dots that emit at different wavelengths based on size (565 nm, 655 nm, 705 nm, or 800 nm emission wavelengths), which are suitable for use in arrays for biological applications as described herein are available from Invitrogen (Carlsbad, Calif.).

Optionally, the emission of semiconductor nanocrystals can be enhanced by overcoating the particle with a material that has a higher bandgap energy than the semiconductor nanocrystal core. Suitable materials for overcoating are disclosed in U.S. Pat. No. 6,274,323, which is incorporated herein by reference.

These and many other aspects of semiconductor nanocrystal design are disclosed in U.S. Pat. Nos. 5,990,479; 6,114,038; 6,207,392; 6,306,610; 6,500,622; 6,709,929; 6,914,256; and in U.S. Patent Publication No. 2003/0165951, which are incorporated herein by reference to the extent they disclose design of semiconductor nanocrystals.

Separate populations of semiconductor nanocrystals can be produced that are identifiable based on their different spectral characteristics. In the context of the arrays and methods disclosed herein, separate populations of semiconductor nanocrystals with different emission spectra can be used to identify different cells or subsets of cells. For example, each of two or more different populations of semiconductor nanocrystals to which specific binding agents are attached (e.g. conjugated) can be placed on an array at a predetermined and/or addressable location. The characteristic emissions can be observed as colors (if in the visible region of the spectrum) or can be decoded to provide information about the particular wavelength at which the discrete transition is observed. Likewise, for semiconductor nanocrystals producing emissions in the infrared or ultraviolet regions, the characteristic wavelengths that the discrete optical transitions occur at provide information about the identity of the particular semiconductor nanocrystal, and hence about the identity of or location of the analyte of interest. The color of light produced by a particular size, size distribution and/or composition of a semiconductor nanocrystal can be readily calculated or measured by methods which will be apparent to those skilled in the art. As an example of these measurement techniques, the bandgaps for nanocrystals of CdSe of sizes ranging from 12 Å to 115 Å are given in Murray et al., J. Am. Chem. Soc. 115:8706, 1993. These techniques allow ready calculation of an appropriate size, size distribution and/or composition of semiconductor nanocrystals and choice of excitation light source to produce a nanocrystal capable of emitting light device of any desired wavelength.

Methods and devices for eliciting and detecting emissions from semiconductor nanocrystals are well known in the art. In brief, a light source typically in the blue or UV range that emits light at a wavelength shorter than the wavelength to be detected is used to elicit an emission by the semiconductor nanocrystals. Numerous such light sources (and devices incorporating such light sources are known in the art, including without limitation: deuterium lamps and xenon lamps equipped with filters, continuous or tunable gas lasers, such as argon ion, HeCd lasers, solid state diode lasers (e.g., GaN, GaAs lasers), YAG and YLF lasers and pulsed lasers. The emissions of arrayed semiconductor nanocrystals can similarly be detected using known devices and methods, including without limitation, spectral imaging systems such as those disclosed in U.S. Pat. No. 6,759,235, which is incorporated herein by reference. Optionally, the emissions are passed through one or more filters or prisms prior to detection.

### Specific Binding Agents

The arrays and methods disclosed herein involve nanoparticles, such as semiconductor nanocrystals, associated with a specific binding molecule or affinity molecule that binds to a biomolecule of interest, such as a biomolecule expressed by a cell. Without limitation, nanoparticle conjugates can include any specific binding molecules (or molecular complexes), linked to a nanoparticle, which can interact with a biological target, to detect biological processes, or reactions, as well as alter biological molecules or processes. Typically, the specific binding molecules physically interact with a biomolecule. Preferably, the interactions are specific. The interactions can be, but are not limited to, covalent, noncovalent, hydrophobic, hydrophilic, electrostatic, van der Waals, or magnetic interactions. In certain examples, the specific binding molecules are antibodies. However, one of skill in the art will recognize that the class of specific binding agents includes a wide variety of agents that are capable of interacting (binding) specifically to a biomolecule, such as a biomolecule expressed by a cell, such as receptors and receptor analogues, ligands, including small molecule ligands and other binding partners.

Nanoparticle conjugates, such as semiconductor nanocrystal conjugates, can be made using techniques known in the art. For example, moieties such as TOPO and TOP, generally used in the production of semiconductor nanocrystals, as well as other moieties, can be readily displaced and replaced with other functional moieties, including, but not limited to carboxylic acids, amines, aldehydes, and styrene to name a few. One of ordinary skill in the art will realize that factors relevant to the success of a particular displacement reaction include the concentration of the replacement moiety, temperature and reactivity. Thus, for the purposes of the present invention, any functional moiety can be utilized that is capable of displacing an existing functional moiety to provide a nanoparticle with a modified functionality for a specific use. The ability to utilize a general displacement reaction to modify selectively the surface functionality of the semiconductor nanocrystals enables functionalization for specific uses. For example, because detection of biomolecules and/or cells is typically carried out in aqueous media (such as buffers and/or culture media), one example of the present invention utilizes nanoparticles (such as, semiconductor nanocrystals) that are solubilized in water. In the case of water-soluble nanoparticles, the outer layer includes a compound having at least one linking moiety that attaches to the surface of the particle and that terminates in at least one hydrophilic moiety. The linking and hydrophilic moieties are spanned by a hydrophobic region sufficient to prevent charge transfer across the region. The hydrophobic region also provides a “pseudo-hydrophobic” environment for the nanoparticle and thereby shields it from aqueous surroundings. The hydrophilic moiety can be a polar or charged (positive or negative) group. The polarity or charge of the group provides the necessary hydrophilic interactions with water to provide stable solutions or suspensions of the nanoparticle. Exemplary hydrophilic groups include polar groups such as hydroxides (—OH), amines, polyethers, such as polyethylene glycol and the like, as well as charged groups, such as carboxylates (—CO²—), sulfonates (SO₃—), phosphates (—PO₄²⁻ and —PO₃²⁻), nitrates, ammonium salts (—NH⁴⁺), and the like. A water-solubilizing layer is found at the outer surface of the overcoating layer. Methods for rendering nanoparticles water-soluble are known in the art and described in, e.g., International Publication No. WO 00/17655. The affinity for the nanoparticle surface promotes coordination of the linking moiety to the nanoparticle outer surface and the moiety with affinity for the aqueous medium stabilizes the nanoparticle suspension. A displacement reaction can be employed to modify the nanoparticle to improve the solubility in a particular organic solvent.

The surface layer can also be modified by displacement to render the nanoparticle reactive for a particular coupling reaction. For example, displacement of TOPO moieties with a group containing a carboxylic acid moiety enables the reaction of the modified nanoparticles with amine containing moieties (commonly found on solid support units) to provide an amide linkage. Additional modifications can also be made such that the nanoparticle can be associated with almost any solid support (e.g., to form an array).

Nanoparticles, such as semiconductor nanocrystals, of varying sizes (e.g., 1-100 nm), composition, and/or size distribution are conjugated to specific binding molecules which bind specifically to a biomolecule of interest. The specific binding molecules is selected based on its affinity for the particular biomolecule of interest. The affinity molecule can comprise any molecule capable of being linked to one or more nanoparticles that is also capable of specific recognition of a particular substance (such as a biomolecule) of interest. In general, any affinity molecule useful in the prior art in combination with a dye molecule to provide specific recognition of a detectable substance will find utility in the formation of the nanoparticle (e.g., semiconductor nanocrystal) probes. Such specific binding molecules include, by way of example only, such classes of substances as monoclonal and polyclonal antibodies, nucleic acids (both monomeric and oligomeric), proteins, polysaccharides, and small molecules such as sugars, peptides, drugs, and ligands. Lists of such affinity molecules are available in the published literature such as, by way of example, the Handbook of Fluorescent Probes and Research Chemicals (sixth edition) by R. P. Haugland, available from Molecular Probes, Inc.

In certain examples, the specific binding molecule is an antibody. More specifically, the specific binding molecule can be derived from polyclonal or monoclonal antibody preparations, can be a human antibody, or can be a hybrid or chimeric antibody, such as a humanized antibody, an altered antibody, F(ab′).sub.2 fragments, F(ab) fragments, Fv fragments, a single-domain antibody, a dimeric or trimeric antibody fragment construct, a minibody, or functional fragments thereof which bind to the biomolecule of interest.

Antibodies of use with the nanoparticle probes can be produced using standard procedures described in a number of texts, including Harlow and Lane (Antibodies, A Laboratory Manual, CSHL, New York, 1988). The determination that a particular agent binds substantially only to the specified target molecule (e.g., a protein) can readily be made by using or adapting routine procedures. One suitable in vitro assay makes use of the Western blotting procedure (described in many standard texts, including Harlow and Lane (Antibodies, A Laboratory Manual, CSHL, New York, 1988)). Western blotting can be used to determine that a given binding agent binds substantially only to the desired target molecule.

Shorter fragments of antibodies can also serve as specific binding agents on the nanoparticles. For instance, Fabs, Fvs, and single-chain Fvs (SCFvs) that bind to a specified protein would be specific binding agents. These antibody fragments are described as follows: (1) Fab, the fragment which contains a monovalent antigen-binding fragment of an antibody molecule produced by digestion of whole antibody with the enzyme papain to yield an intact light chain and a portion of one heavy chain; (2) Fab′, the fragment of an antibody molecule obtained by treating whole antibody with pepsin, followed by reduction, to yield an intact light chain and a portion of the heavy chain; two Fab′ fragments are obtained per antibody molecule; (3) (Fab′)₂, the fragment of the antibody obtained by treating whole antibody with the enzyme pepsin without subsequent reduction; (4) F(ab′)2, a dimer of two Fab′ fragments held together by two disulfide bonds; (5) Fv, a genetically engineered fragment containing the variable region of the light chain and the variable region of the heavy chain expressed as two chains; and (6) single chain antibody (“SCA”), a genetically engineered molecule containing the variable region of the light chain, the variable region of the heavy chain, linked by a suitable polypeptide linker as a genetically fused single chain molecule. Methods of making these fragments are routine.

Optionally, the specific binding agents are attached to the nanoparticle via a linker, such as a streptavidin-biotin interaction. However, many different types of linking agents can alternatively be used to link the specific binding agent to the nanoparticle. Moreover, the linking agent can be in the form of one or more linking agents linking one or more nanoparticles to one or more affinity molecules. Alternatively, two types of linking agents can be utilized. One or more of the first linking agents can be linked to one or more nanoparticles and also linked to one or more second linking agents. The one or more second linking agents can be linked to one or more specific binding molecules and to one or more first linking agents.

One form in which the nanoparticle can be linked to an affinity molecule via a linking agent is by coating a semiconductor nanocrystal with a thin layer of glass, such as silica (SiOₓ where x=1-2), using a linking agent such as a substituted silane, such as 3-mercaptopropyl-trimethoxy silane to in the nanocrystal to the glass. The glass-coated semiconductor nanocrystal can then be further treated with a linking agent, such as an amine such as 3-aminopropyl-trimethoxysilane, which will function to link the glass-coated semiconductor nanocrystal to the affinity molecule. That is, the glass-coated semiconductor nanocrystal can then be linked to the affinity molecule. The original semiconductor nanocrystal compound can also be chemically modified after it has been made in order to link effectively to the affinity molecule. A number of references summarize the standard classes of chemistry which can be used to this end, in particular the Handbook of Fluorescent Probes and Research Chemicals (6th edition) by R. P. Haugland, available from Molecular Probes, Inc., and the book Bioconjugate Techniques by Greg Hermanson, available from Academic Press, New York.

When the semiconductor nanocrystal can be coated with a thin layer of glass, the glass, by way of example, can comprise a silica glass (SiOₓ where x=1-2), having a thickness ranging from about 0.5 nm to about 10 nm, and preferably from about 0.5 nm to about 2 nm.

The semiconductor nanocrystal is coated with the coating of thin glass, such as silica, by first coating the nanocrystals with a surfactant such as tris-octyl-phosphine oxide, and then dissolving the surfactant-coated nanocrystals in a basic methanol solution of a linking agent, such as 3-mercaptopropyl-tri-methoxy silane, followed by partial hydrolysis which is followed by addition of a glass-affinity molecule linking agent such as amino-propyl trimethoxysilane which will link to the glass and serve to form a link with the affinity molecule.

These and many other techniques for linking specific binding agents to nanoparticles, such as semiconductor nanocrystals (including quantum dots), are found in U.S. Pat. No. 5,990,479 at columns 7-8, which columns are incorporated by reference.

### Nanoparticle Arrays

In the context of the present disclosure, the nanoparticle probes are attached to a substrate at addressable locations to form arrays. In an array, a location is said to be “addressable” if the location is capable of being reliably and consistently located and identified. An addressable location can be identified because it is predetermined on a 2-dimensional or 3-dimensional substrate, because the object positioned at the location is reliably and consistently identifiable, or both. In certain examples, the nanoparticle probes are identifiable by one or more characteristics inherent to the particle that enables direct or indirect identification of the nanoparticle using any means of detection. The position of such a nanoparticle on an array is addressable by means of detecting the identifying characteristic. As discussed above, semiconductor nanocrystals with specific binding molecules are one example of an identifiable nanoparticle probe. When placed in or on an array, the location of the semiconductor nanocrystal is identifiable by detecting a spectral emission characteristic of the nanoparticle.

When two or more nanoparticle probes having different specific binding molecules are to be arranged in an array, two or more different nanoparticles having different detectable characteristics can be used. Typically, the characteristics of the nanoparticles are selected so that each specific binding molecule can be uniquely correlated with the detectable characteristic of the nanoparticle to which it is attached. Thus, nanoparticle probes with more than one specific binding capability can be co-arrayed so that the probes having different binding specificities are nonetheless identifiable within the array. Thus, the relative positions of nanoparticle probes with different specific binding molecules can be unambiguously identified based on the different characteristics of the selected nanoparticles. In one example, the nanoparticles are semiconductor nanocrystals identifiable by the color of their emission spectra.

This analysis can be carried out by conventional fluorescent microscopy techniques (e.g., using a CCD) or by use of a spectral scanning device. Since many nanoparticle probes can be generated that are spectrally distinct, it is possible to label nanoparticle probes with different specific binding agents (such as antibodies) that can then be used to detect the identity, position, and/or activities of biomolecules and cells. The number of biomolecules that can be evaluated is limited only by the number of spectrally distinct colors that can be made. For example, CdSe, semiconductor nanocrystals can be synthesized in approximately 6-7 spectrally distinct colors. Thus, as many as 6 or 7 different biomolecules or types (or subtypes) of cells can be identified, collected, sorted, purified and/or analyzed using a single array.

Optionally, the nanoparticle probes (and/or different nanoparticle probes) are arranged in predetermined locations of the array.

The substrate of the array can be any solid support, that is, any insoluble material to which a nanoparticle probe can be attached. A solid support can be any material that provides an insoluble matrix under the conditions of intended use. Typically, solid supports in the context of this disclosure are insoluble under conditions suitable for the identification, capture, analysis and optionally, the growth of cells (e.g., in aqueous solutions, such as buffers and cell-culture media). Typically, the solid support has a rigid or semi-rigid surface. Exemplary solid supports include but are not limited to slides, chips, disks, pellets, pins, needles, solid fibers, capillaries, hollow fibers, beads (e.g., cellulose beads, poreglass beads, silica gels, polystyrene beads optionally cross-linked with divinylbenzene, grafted co-poly beads, polyacrylamide beads, polystyrene latex beads, dimethylacrylamide beads optionally crosslinked with N-N′-bis-acryloylethylenediamine) and glass particles coated with a hydrophobic polymer. Additional solid supports include substrates such as nitrocellulose (e.g., in membrane form), polyvinylchloride (e.g., sheets), polyvinylidine fluoride, diazotized paper, nylon membranes, and the like.

For example, the semiconductor nanocrystals of the present invention can readily be functionalized to create styrene or acrylate moieties, thus enabling the incorporation of the semiconductor nanocrystals into polystyrene, polyacrylate or other polymers such as polyimide, polyacrylamide, polyethylene, polyvinyl, polydiacetylene, polyphenylene-vinylene, polypeptide, polysaccharide, polysulfone, polypyrrole, polyimidazole, polythiophene, polyether, epoxies, silica glass, silica gel, siloxane, polyphosphate, hydrogel, agarose, cellulose, and the like. For a detailed description of exemplary linking reactions, see, for example, U.S. Pat. No. 5,990,479.

In some embodiments, the nanoparticle probes are attached to the surface of the substrate using printing, lithographic, chemical and or biological attachment methods, or a combination thereof. Exemplary methods for the production of nanoparticle probe arrays are described below.

### Production of Nanoparticle Arrays

Nanoparticle probe arrays are produced by incorporating or attaching nanoparticle probes to a substrate in addressable locations. For example, nanoparticle probes can be incorporated into the matrix of certain substrates, such as polymers. Nanoparticle probes can be attached to a substrate either directly or indirectly. In some instances, the nanoparticle probes are first coupled to an intermediate, such as a protein, with desirable solid phase binding properties. Suitable coupling proteins include, but are not limited to, macromolecules such as serum proteins, including bovine serum albumin (BSA), keyhole limpet hemocyanin, immunoglobulin molecules, thyroglobulin, ovalbumin, and other proteins well known to those skilled in the art. Other reagents that can be used to bind molecules to the support include lectin binding agents (such as avidin, steptavidin, and the like), polysaccharides, polylactic acids, polyglycolic acids, polymeric amino acids, amino acid copolymers, etc. Such molecules and methods of coupling these molecules are well known to those of ordinary skill in the art. See, e.g., Brinkley, M. A. Bioconjugate Chem. 3:2-13, 1992; Hashida et al., J. Appl. Biochem. 6:56-63, 1984; and Anjaneyulu and Staros, International J. of Peptide and Protein Res. 30:117-124, 1987.

Various methods are known in the art for attaching nanoparticles in predetermined locations on a substrate. For example, U.S. Pat. No. 7,015,139 discloses a method for producing two-dimensional arrays of metal atom nanoparticles. U.S. Pat. No. 6,962,823 discloses methods for assembling a wide variety of nanostructures by patterning nanostructure catalysts on a substrate. Nanostructures are then assembled in situ via aggregation at the sites of the nanostructure catalysts. Additional methods for assembling nanoparticles on arrays are provided, e.g., in U.S. published application no. 20060087048 and 20030021982. These references are incorporated herein by reference for all purposes.

Photolithographic soft printing can also be used to produce nanoparticle probe array platforms. Photolithographic printing has been used in semiconductor fabrication and polymer science technology to produce surfaces that contain patterns on the order microns. Surfaces created using this technique are highly reproducible and have been implemented for use as tools in biotechnology and biological research, including molecular patterning, fabrication of cellular environments, and the building of scaffolds for tissue engineering. This printing technique can be used to create a single platform with QDs that fluoresce in one or more colors to target, select and capture cells for purification and/or in vitro analysis. For example, QDs that fluoresce in one color can be used to identify and capture a particular type of cell, optionally in combination with QDs that fluoresce another color to capture a different type of cell onto the same platform. Such QD platforms overcome technical limitations encountered in traditional in vitro work, such as lack of cell selectivity and positioning.

The following is a simple and improved method for printing nanoparticles onto the surface of a substrate. This technique can be used to print any type of nanoparticle on to the substrate. For example, this method can be used to apply nanoparticles made of metal, metal oxides, silica (e.g., dye-doped silica), or semiconductor nanocrystals to a substrate of glass, silica, plastic (or other polymer), nylon, metal, etc. For simplicity, the method is particularly illustrated herein by the example of printing semiconductor nanocrystals or quantum dots in a predetermined array pattern onto a glass surface (for example, a glass slide or chip).

Poly(dimethylsiloxane) (PDMS) polymer-negative molds, created from 3-D photoresist-patterned silicon wafers, are adsorbed with quantum dots and used as stamps to print quantum dots onto a glass surface.

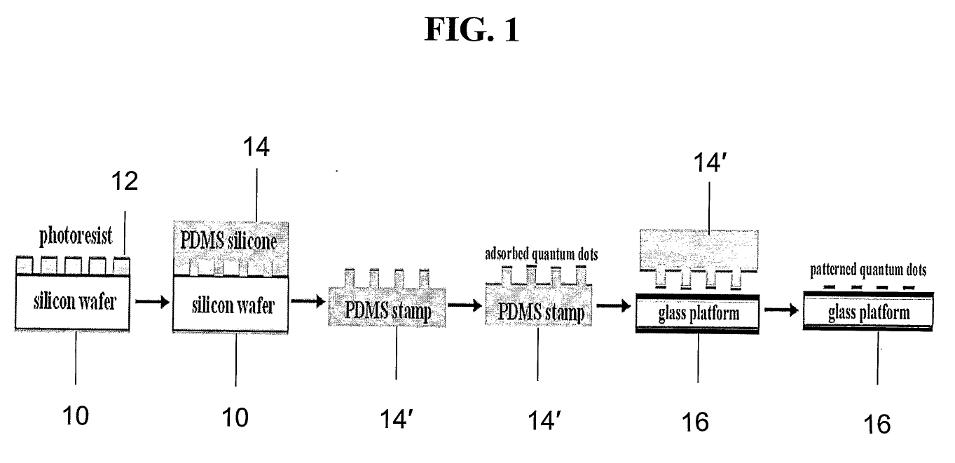

An exemplary method is schematically depicted in FIG. 1. A PDMS stamp is produced using replica molding, and a desired pattern is transferred by microcontact printing. The process begins by exposing photoresist on a silicon support 10 to ultraviolet light through a mask which can be prepared by commercial or desktop printing. After dissolving the unexposed photoresist, cured photoresist 12 remains on the silicon support in a bas-relief pattern defined by the mask. This bas-relief pattern is referred to as a master. The master is exposed to vapors of CF₃(CF₂)₆(CH₂)SiCl₃ overnight to reduce its tendency to adhere to the stamp. A PDMS elastomer 14 (such as Sylgard 184) is poured over the master and cured (e.g., for 2 hours at 60° C.). After curing, the free PDMS stamp 14′ is peeled off the master and inked with a solution of nanoparticles, such as quantum dots. The stamp is then used to transfer the nanoparticles on to a glass substrate 16. After the stamp is removed, it leaves behind a pattern of nanoparticles in separate confluent monolayers at discrete separate locations on glass substrate 16.

In certain embodiments, the nanoparticles are functionalized and applied to a surface that is treated to incorporate a corresponding functionality as described above.

Although any nanoparticle can be attached to an array surface for the presentation of specific binding agents to bind targets (such as biomolecules and/or cells), this method is further described using the example of semiconductor nanocrystals (quantum dots). This method provides an approach for fabricating nanoparticle probes that permits well-controlled placement of a monolayer of high-density nanoparticle quantum dots with an attached specific binding molecule (exemplified in one specific example described below by neural attractive capture antibodies that will capture and selectively spatially position on a substrate selected neurons through attractive binding to particular neural surface antigens present on neural cell surfaces).

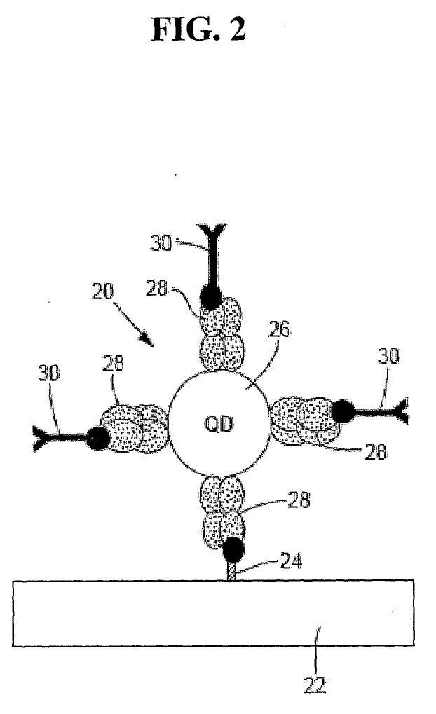

A schematic drawing of a specific example of a nanoparticle probe array 20 is shown in FIG. 2. The device 20 includes a glass substrate 22 that is optically clear and can be used for analysis in fluorescence-based as well as topographical (AFM) and cell culture studies. The glass surface of substrate 22 is derivatized (for example by aminosilanization) to introduce amine functional groups to which are attached biotin-PEO4 linker molecules to immobilize quantum dots 26 onto the glass surface. Quantum dots 26 each have numerous streptavidin binders 28, some of which will bind to the biotin-PEO₄ linker arm 24 of the glass surface to immobilize the quantum dot at a selected location on substrate 22. The linker molecules are of sufficient length (such as 2-3 Å, 4 monomer units) to provide a flexible arm that allows sufficient exposure of quantum dot surfaces so that they can interact freely with cells exposed to the platform. In other examples, the linker arm is at least 2-3 Å in length, for example at least 5 Å in length, or 1-5 or 1-10 Å in length. Remaining streptavidin binding sites on quantum dot 26 are each available for binding a biotinylated capture antibody 30.

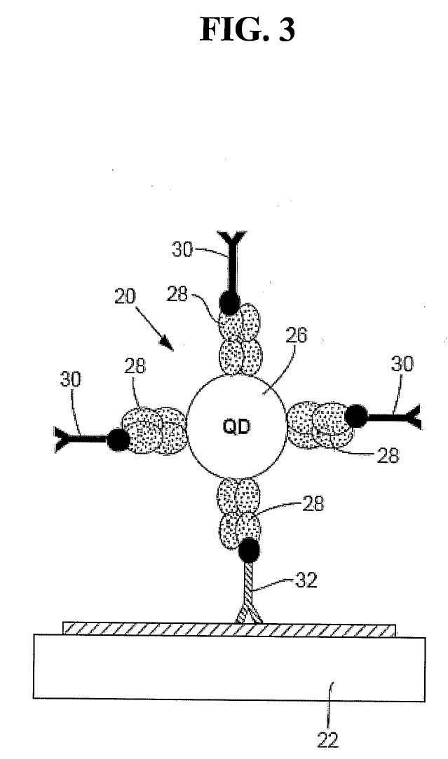

Alternatively, as shown in FIG. 3, substrate 22 can be coated with extracellular matrix proteins (ECM) such as collagen, and the quantum dot attached to substrate 22 by a biotinylated anti-collagen antibody 32. One purpose of using ECM proteins is to introduce to the substrates natural signaling and growth molecules that would render the surface more biocompatibile for longer term in vitro survival of cells. The biotin of the antibody binds to the streptavidin on quantum dot 26, and the anti-collagen antibody binds to the collagen fibrils on substrate 22.

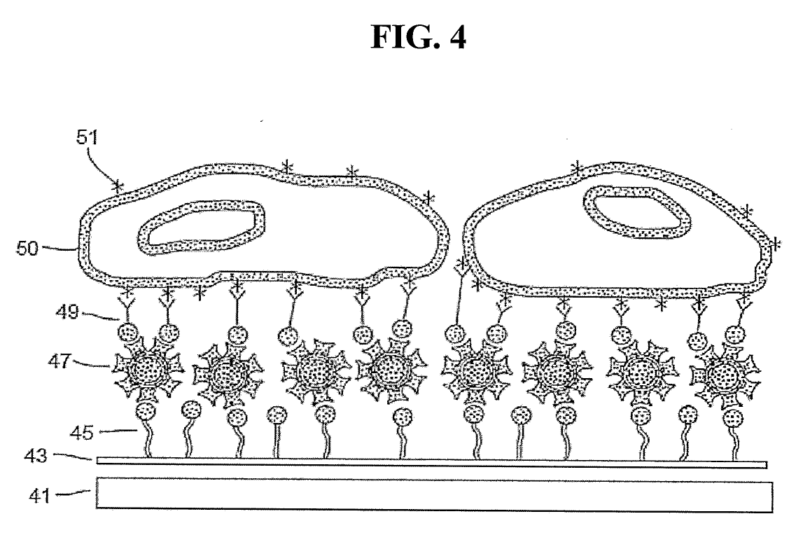

FIG. 4 schematically illustrates one embodiment of the device in which a flat glass substrate 41 has a layer of silane 43 on it, to which are attached PEG linkers having a biotin head 45. The biotin head is attaches to streptavidin molecules on the surfaces of the quantum dots 47 to bind the quantum dots to the silanized glass substrate. Biotinylated capture antibodies 49 in turn bind to the streptavidin on the quantum dots, and have a specific binding affinity for antigens 51 on the surfaces of cells 50. As shown in FIG. 4, the cells are therefore bound to the quantum dots to retain the target cells in stable association with the quantum dots and the substrate. The surface antigens on the illustrated cells can be either the same antigen (when binding targeting target cells that have the antigen) or different antigens (for example when selectively positioning cells that express different target antigens adjacent one another).

Quantum dots can alternatively be adsorbed or covalently bound onto the glass surface. Covalent bonds are more stable and preferable to adsorption because cross-linking with spacer arms permits the quantum dots to be attached with flexibility and provides greater accessibility for interactions with subsequent chemical reactions. Derivatization using ATPES silane is a widely used approach for attachment of nucleotides onto solid-support surfaces such as glass or silicon dioxide, and it is commonly used for commercial production of gene microarrays. APTES is also particularly preferable as the silane because it is inexpensive, can be obtained commercially in high purity, and provides more reactive substrates than hydroxyl functionalized surfaces.

To help enhance efficiency, accuracy, and uniformity of the quantum dot platforms, glass solid-support surfaces are initially cleaned to remove residual oils and dirt that can interfere with subsequent reaction steps. Glass is cleaned with ‘Piranhna’ solution (H₂SO₄ and H₂O₂), rinsed with water, and then immersed in NaOH to regenerate an even layer of hydroxyl functional groups on the glass surface. The surface is again rinsed with water and then immersed in HCl to neutralize any remaining base, and rinsed with water. Cleaned glass coverslips are derivatized by immersing them for 10 min in 2% APTES in toluene, rinsed in dH₂O, and baked at 110° C. for 10 min to produce a stabilized silane bound glass surface containing amino-functional groups to which the biotin-PEO₄—NHS linker arm can be attached.

Streptavidin (10 mg/ml) is covalently bound to the surface of quantum dots, using BIS[sulfosuccinimidyl] suberate (Pierce) functionalization, to the amino groups on polyacrylic acid-coated surface of quantum dots. Streptavidin conjugated quantum dots are available from Quantum Dot Corp, of Hayward, Calif.).

PDMS stamps (grooved patterns, 10 μm lanes) are formed by curing Sylguard 185 (10:1 ratio of elastomer:curing agent) to form negative molds of photolithographically patterned photoresist silicon wafers using a mask consisting of a high-resolution printed image created in Photoshop. PDMS stamps are ethanol cleaned and sonicated, dried with a stream of N₂, and inked with QD solution for 20 mins in a covered Petri dish. Inked stamps are washed in a 10 ml volume of PBS, followed by a 10 ml volume of ultrapure dH₂O. The stamps are dried for approximately 90 secs under a N₂ stream. Quantum dots are printed onto biotin-PEO₄/silane glass surfaces by placing PDMS stamps onto surfaces for 60 secs, then gently lifting the PDMS stamp with forceps. The quantum dot microarray platform is then rinsed in dH₂O to remove unbound quantum dots (QDs).

The quality of resulting QD platforms as well as each of the successive underlying silane/QD/Ab platform layers can be evaluated for spatial uniformity, density and stability to optimize design parameters prior to use in a capture assay. For example, uniformity of the QD platforms and underlying silane/QD/Ab layers can be visualized using a fluorescence microscope to look at micron scale uniformity, followed by atomic force microscopy (AFM) to evaluate the organization and height of the QD platform after each successive layer has been deposited. Efficiency of the silane derivitization process, e.g., the density and uniformity of amine functional groups on the glass surface can be assessed by adding a fluorophore which binds to reactive groups. Uniformity of subsequent silane/QD layers can be assessed by looking at QD fluorescence for different QD incubation concentrations to determine the optimum QD concentration that will yield a uniform and a high density (high fluorescence) signal. Uniformity and high density of Abs on the resulting QD platform (silane/QD/Ab) can be evaluated by incubating the QD platform with a secondary fluorescent Ab and examining the fluorescence signal. AFM measurements can be taken of these same successive layer surfaces (silane/QD/Ab) to monitor increases in nanoscale thickness. Histograms of heights across a single platform and among several platforms can be compiled to quantify the variability of QD and collagen-platform patterns. To evaluate the spatial conformity the QD pattern onto the platform, images of the PDMS stamp and QD fluorescent pattern can be overlaid and the percentage of overlap determined.

To determine long-term stability of QD platforms, the platforms can be incubated in PBS for an extended period of time (such as up to or exceeding 2 weeks), during which time fluorescent-microscope images will be sampled and the QDs integrated for brightness to evaluate how well the QDs stay adhered to the platform surface.

### Methods for Identifying and Collecting Biomolecules Using Nanoparticle Probe Arrays

The nanoparticle arrays disclosed herein can be used in for the ultra-sensitive and quantitative detection of multiple target biomolecules (e.g., proteins) in complex fluids, such as biological fluids, including for example, blood, serum, plasma, urine, sputum, cerebrospinal fluid, amniotic fluid, and the like, as well as homogenates and/or lysates of biological samples, such as cells. For example, nanoparticles that have attached specific binding molecules that interact specifically with the biomolecule of interest in the fluid sample are arrayed on a substrate. Optionally, multiple different nanoparticles with different specific binding molecules are placed distributed in the same array. In some embodiments, the different nanoparticles are arranged on the substrate in spatially distinct regions, e.g., at predetermined locations of the array. In certain examples, the nanoparticles are identifiable by at least one detectable characteristic, such that the identity of the specific binding molecule (and hence the biomolecule of interest) can be identified based on the characteristic of the nanoparticle. In one particular example, the self-identifiable nanoparticles are semiconductor nanocrystals (e.g., quantum dots).

A biological fluid is contacted with the array, where the biomolecule(s) of interest are captured, and optionally sorted, in the case of arrays with multiple different nanoparticles with different binding specificities. In certain embodiments, the specific binding agent is attached to the nanoparticle by a cleavable linker, such that the captured biomolecule can be released and isolated (for example, by exposure to ultraviolet light). Biomolecules captured on (and optionally isolated from) these arrays are suitable for subsequent analysis by any of a variety of methods known to those of skill in the art for the analysis of biomolecules (such as for diagnostic or prognostic purposes). For example, captured biomolecules can be characterized in the context of the array (for example, by such methods as AFM), or released for subsequent analysis.

### Methods for Identifying and Capturing Cells Using Nanoparticle Probe Arrays

The nanoparticle arrays described herein are useful for the collection, identification and analysis (including long-term in vitro analysis of biological activity) of cells. The arrays can be adapted to capture essentially any cell or cells of interest based on the selection of the specific binding molecule(s) attached to the nanoparticles. In certain examples, the nanoparticles are identifiable by a detectable characteristic (such as, in the case of semiconductor nanocrystals, emitted light of a particular color). By using identifiable nanoparticles at predetermined and/or addressable locations, the identity and relationship of different cellular components of a mixed population of cells (such as a disaggregated tissue sample, a suspension of biological material or an environmental sample, e.g., of water, soil, etc.) can be evaluated.

It will be understood by one of ordinary skill in the art that the arrays and methods described herein are applicable in a wide variety of contexts and to an essentially limitless list of cells. In the following illustrative example, the arrays are used to capture (collect) and separate (sort) different subtypes of neurons from a mixed population of neural tissue. This example is selected because neuronal tissue includes vastly diverse populations of neurons, which have proven difficult to collect and analyze using previously available methods. Typically, methods for establishing highly pure neuronal cell lines have been time- and resource-consuming and technically complex. Simpler methods yield cultures that either sacrifice yield for purity or are contaminated with several neuron cell types and other glia, fibroblasts, and endothelial cells. For example, mechanical/density-gradient purification and selective pharmacological killing of select cell types in heterogeneous cultures have not been highly successful in differentiating neurons which do not differ substantially in morphology and pharmacology. More sophisticated techniques such as microdissection are not useful with neural tissue that is composed of complex distributions of neuronal networks that are physically apposed or intertwined with one another. Furthermore, although fluorescent-activated cell sorting (FACS) requires expensive equipment that has worked well for immune cells, it has not provided good yields for neuronal cell populations and it sacrifices yield for purity. Additionally, even immunopanning techniques and other methods involving capture antibodies adsorbed to plates or beads (e.g., magnetic or polystyrene beads) that have been used to isolate substantially pure populations of neural cells are incapable of controlling a location at which a selected cell type attaches to a surface, typically requiring that the cells be fixed and stained for accurate identification. The arrays and methods disclosed herein solve these problems as illustrated in the following example.

The retina is a complex heterogeneous population that contains a mixture of neuronal and glial cells that express antigens specific for different retinal phenotypes, including photoreceptors, bipolar cells, retinal ganglion cells, and retinal glial cells. Cell surface receptors and antibodies for these different cell types have been well-characterized and are readily available. The devices and methods disclosed herein are capable of sorting the different cell types in the retina to specific locations on a quantum dot nanoparticle probe array where quantum dots with specific binding molecules for different cell types emit a different characteristic signal, such as a color of light, for example red, orange, yellow, blue or green light. The locations to which a particular cell type has been sorted and bound can then be identified by stimulating the quantum dots with a trigger light source that induces the quantum dots to emit light of the particular color associated with the specific binding molecule, and thus the cell type.

The rat retinal precursor cell line E1A-NR.3 is used to demonstrate cell sorting with the nanoparticle array. The E1A-NR.3 cell line has been used in various established retinal cell models of neurodegeneration (such as glutamate excitotoxicity, ischemia, and NT factor withdrawal).

A collagen coated quantum dot probe array is formed by first heterogeneously charging the glass substrate with “islands” of positive charge. A PDMS pattern consisting of grooves 20 μm wide and spaced 40 μm apart is placed on a glass slide to mask existing negatively charged glass regions. Exposed glass is positively charged by amino functionalization (APTES silane) to provide a functionalized substrate surface as shown in FIGS. 3 and 4. Collagen is flowed over the surface of the heterogeneously charged glass at low density (0.1 mg/ml) and physiological pH (PBS, 200 nM NaCl, pH7.4) to create self-assembled, aligned, single nanofibrils of collagen surfaces (300 nm long, 1.5 nm thick) that are electrostatically bound to positively charged glass regions. This surface is then incubated with biotinylated anti-collagen antibody, which is bound to exposed regions on individual collagen fibers. The ultra-thin layer of collagen and the high surface-to-volume ratio of each collagen fibril help assure that the biotinylated anti-collagen antibody binds to the surface-exposed collagen, providing freely exposed biotin binding sites. The streptavidin-coated quantum dots are exposed to the anti-collagen antibody-collagen/glass surfaces and bound to the collagen via the antibody molecular “glue.” Remaining streptavidin sites on each quantum dot are bound with neuron-specific capture target antibodies though a final incubation step. These capture target antibodies are biotinylated and reactive for a variety of neuron- or glial-specific surface proteins and are bound to quantum dot surfaces via biotin-streptavidin linkers. The biotin-streptavidin bond helps retain the bioactivity of immobilized ligands and antibodies. The biotin-streptavidin bonds are also strong and highly resistant to pH changes, and possess mild chemistry that can be adjusted by varying the stoichiometry of the binding partners.

The E1A-NR3 mixture of cells is introduced to the array surface on which the quantum dots are immobilized. Each platform contains individual red quantum dots that have capture antibodies that specifically bind known antigens expressed in E1A-NR.3 cells: GABA-A receptors (horizontal cells, bipolar cells), rhodopsin (photoreceptors), Thy-1 (ganglion cells), and GFAP (glial cells). Cells that adhere to the platform surface are then stained with a solution containing a free-suspension of individual green quantum dots that have capture antibodies that are the same as that which is used for the neuronal capture Abs. For each bound cell, the correspondence between the fluorescence of platform-bound quantum dots and the fluorescence emitted by the free dye-coupled antibody indicate a correspondence in capture selectivity of the cell with its specific antigen.

E1A-NR.3 cells are maintained in DMEM supplemented with 10% FBS. Cells (5×10⁵/ml) are incubated on quantum dot microarrays and on control collagen surfaces (40 min on gentle shaker) and rinsed several times to remove non-adherent cells (3 times, PBS). For cell viability assays, calcein AM and ethidium homodimer-1 are simultaneously added to the cell suspension, which is then incubated for 30-45 min, and individual cells are monitored with a fluorescence microscope. CFDA SE is introduced to cells, and the cell fluorescence is monitored over a 1-week period.

Conventional procedures are used to make collagen surfaces that will serve as controls. Glass slides are incubated with collagen (50 μg/ml) and then rinsed 3 times with PBS.

The quality of the quantum dot probes sensitively bind to target cells while giving a minimum of false signals (having high specificity). Quantum dot probe cell selectivity is quantified by histogram counts of “hits” (cells bound to platform by immobilized red quantum dots and labeled by a free-suspension of green quantum dots) and “false positives” (cells bound to platforms by immobilized red quantum dots but not labeled by green quantum dots). To evaluate differences in biocompatibility of quantum dot surfaces, the percentages of live and dead cells that adhere are compared to those live and dead cells adhering to control surfaces.

For each bound cell, the correspondence between the fluorescence of platform-bound quantum dots and the fluorescence emitted by the free dye-coupled antibody indicates a correspondence in capture selectivity of the cell with its specific antigen. Measurements of cell toxicity are performed by determining spectrophotometrically the activity of lactic acid dehydrogenase (LDH) released from the cytoplasm of injured cells into the culture medium. Cell proliferation is assessed by MTT uptake of live cells and quantitated by colorimetric assay. Both these assays are widely used to determine neuronal viability in the retina and brain, and account both for cells adherent and detached in the cell media, for both QD platform and control collagen conditions.

The biocompatibility of cells adhering to quantum dot layers can be assessed for extended periods of time in culture (e.g., up to 7 or more days) using cell viability assays, and assessed with respect to cell morphology (granularity of cell body, length of neural processes) is initially compared. For example, cell viability can be assessed using a live/dead assay (calcein AM and ethidium homodimer-1) and cell proliferation assay (CFDA SE).

The cells adhering to the substrate can also be analyzed to assess their electrical excitability. Presynaptic and postsynaptic neuron subtypes can be spatially micro-positioned to induce electrical excitability through synaptic contacts. Tests for synaptic activity are performed using calcium imaging. Pharmacological effects are assessed by then using drugs to block the induced synaptic activity. In this manner, the micro-positioned cells are used to study inter-neuronal communication and test functionality in terms of electrical activity.

For example, following capture and positioning on the nanoparticle array, various biological characteristics and activities of the cells can be assessed. In the following illustrative example, subsets of neurons are captured and positioned on an array, and the effect of neuroactive agents is evaluated.

Neurotrophins (NTs) play an integral role in promoting neuronal survival, differentiation, and injury-induced repair. NT actions in the nervous system are well-documented and widespread, and have engendered strong interest in NTs as potent compounds for treating neurodegenerative diseases. A local, regulated supply of NTs to specific neural populations is now believed to be needed to improve NT effectiveness and reduce detrimental NT side effects. To design effective NT therapies, it is therefore helpful to characterize and assay for NT specific target sites in a variety of neuronal cell subtypes. A definitive identification of the neurons that NTs directly affect is not known because NTs are diffusible and exert long-ranging effects on an impressive range of multiple cell types in neural tissue. The availability of a well-controlled cell assay system would greatly improve an understanding of NT activity in specific types of neurons. Current experimental techniques are limited in that they lack cell selectivity, control of cell spatial interactions, and a means for rapid identification of heterogeneous cell populations, and thus have been amenable only to the analysis of homogenous cell populations (such as PC12 cells). The nanoparticle arrays disclosed herein provide a means to precisely select, position, and rapidly identify the multiple types of neurons that NTs directly act upon. This in turn identifies the types of cells that respond directly to injected NTs.

Using the E1A-NR.3 retinal cell line, different retinal neuronal cells types are selected and positioned on the nanoparticle array, and an assay is performed for each type of cell for direct NT rescue under previously established experimental conditions of glutamate-induced cell death.

Neuronal cell types are selected and positioned using the nanoparticle array. In some examples an entire array will bind only one subtype of cell, while in other examples different portions of one substrate can be dedicated to nanoparticles that bind different cell subtypes. In this example, the different nanoparticles capture surface antigens for photoreceptors, horizontal cells, bipolar cells, and ganglion cells. Glutamate-induced cell death is carried out using DMEM/Ham's F-12 with increased glutamate (>100 uM) to enhance excitotoxicity. This formulation results in selective death of retinal neurons, with no significant effect on glia. MTT cell viability assay is used after 24 and 48 hrs to assess the effectiveness of cell rescue after applying the following NTs: NGF (5 ng/ml), CNTF (1 ng/ml), and BNDF (10 ng/ml). For cells showing increased viability to any of the NTs, experiments are repeated at varying NT concentrations to confirm NT cell rescue as a function of NT dose.

For each type of neuron, viability is compared among the different neuron types tested and among the different NTs.

The following non-limiting experimental examples are provided to further illustrate aspects of the disclosure.

### EXAMPLES

### Example 1

### Nanoparticles Dots can be Micro-Patterned Using Contact Printing Techniques

This example describes the production of nanoparticle probe arrays using photolithography. CdSe quantum dots with streptavidin and PEG on the surface were obtained from Quantum Dot Corp. of Hayward, Calif. Silicon wafers were cleaned with acetone, methanol, and isopropanol, dried with nitrogen, and air dried on a hotplate at 95° C. for 5 minutes. The wafers were spin-coated with SU-80 negative photoresist, soft baked at 50 C for 10 min, and cooled. A Karl Suss mask aligner was used to expose resist at 15 mW/cm2 for approximately 80 s. Exposed wafers were baked for 5 min at 95° C., cooled, and developed in SU8 developer for 6 min to remove unexposed photoresist and residue.

PDMS elastomer (Sylguard 184) and curing agent (10:1 v/v) was poured into a plastic centrifuge tube and thoroughly mixed by hand. The PDMS mixture was warmed in a convection oven for 5 min at 65° C. to remove initial bubbles and then poured over silicon and/or PDMS masters. The masters were placed under vacuum (−15 Hg) and equilibrated to 3 times to remove bubbles. Samples were cured approximately 120 min at 80° C. and cooled to RT. PDMS stamps were obtained by slowly peeling the cured PDMS layer off the silicon wafer/PDMS masters, which revealed the stamping surface that had raised surfaces in a two-dimensional array that corresponded to the pattern in which the quantum dots were to be deposited on the glass substrate.

Stamps were inked by depositing quantum dots suspended in PBS (pH 7.2) onto the PDMS and incubating the stamps for 30 min in a covered Petri dish. Afterwards, the stamps were rinsed in PBS (3×10 mL) followed by dH₂O (3×10 ml) and immersed in a large volume of dH₂O. PDMS stamps were then dried with nitrogen gas.

The quantum dots were stamped onto glass coverslips and glass slides that were cleaned by sonication in 2:1 dH₂O:ethanol for approximately 5 min and dried under a nitrogen stream. Silicon wafers were cleaned by RCA method: wafers were incubated for 5 min in a solution of 1:1:5 ratio of ammonium hydroxide:hydrogen peroxide:deionized water (NH₄OH:H₂O₂:dH₂O), rinsed with dH₂O, then incubated for 5 min at 75-80° C. in a solution of 1:1:6 ratio of HCl:H₂O₂:deionized water to introduce OH groups. Following this step, silanization was performed by incubating in APTES 5% solution in 100% ethanol for two hours. The glass coverslips/slides and wafers were then rinsed with ethanol, followed by DI water, and dried with a N2 gun.

BSA (1% w/w), an adhesive protein and blocking agent was used to reduce non-specific binding by preventing other proteins from being adsorbed onto the surface.

Atomic force microscope (AFM) scans were taken of the stamped glass substrates using a Quesant AFM operated in tapping mode using SiNi tips. Use of the PDMS stamps with micrometer-scale topological features of various sizes and heights ranging from 4.5-6.5 μm had been inked with quantum dot solution. The printed quantum dot pattern was found to form a monolayer of substantially uniform height.

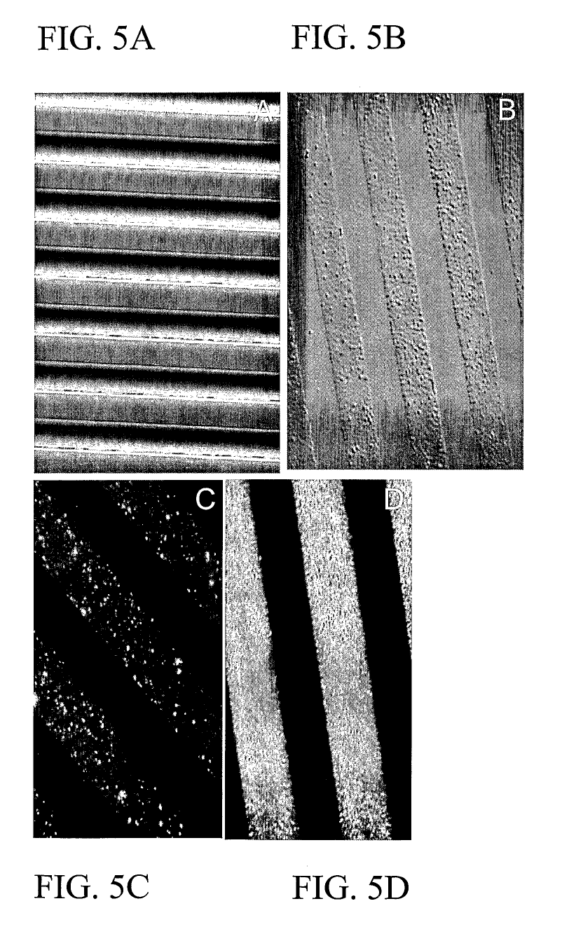

A fluorescent micrograph of the side view of a PDMS polymer stamp is shown against a dark background in FIG. 5A. The raised printing surface presented by the stamp is shown to be a 10 μm square surface that is elevated 6.5 μm above the body of the stamp.

The micrograph of FIG. 5B shows a glass surface printed with yellow quantum dots, except for 4 QD-free squares (10×10 μm), demonstrating that this printing technique has good resolution and allows the precise placement of quantum dots. This micron-scale resolution is on the order of just a single cell body, allowing for the controlled placement of nanoparticles such as quantum dots onto platforms so that the targeted cells captured by the nanoparticles can be spaced appropriately to allow for cell study and manipulation.

FIGS. 5C and 5D show quantum dots printed in pre-defined patterns on a glass surface, demonstrating that quantum dots (or other nanoparticles) can also be precisely placed, at various densities, on substrates. The patterns can, for example, be a two dimensional array of squares (as in FIG. 5D) or linear strips of the nanoparticles (as in FIG. 5C). The linear strips of nanoparticles in FIG. 5C are quantum dots that fluoresce different colors (in this case the dark strips are red quantum dots and the lighter gray narrow strips are green quantum dots). Further, FIG. 5D shows that quantum dots (red and green) can be visualized by color. In a black and white reproduction of this image, green quantum dots are shown as the lighter gray color and the red quantum dots are shown as a darker color. Controlled patterning at different densities and calorimetric identification permit the quantum dots to capture different cells onto a quantum dot microarray to precisely choose and highlight one (or more) of the captured cells for investigation.

### Example 2

### Printed Quantum Dot Microarray Platforms That Consist of Single Quantum Dot Probe Monolayers

Nanoparticle arrays produced as described in Example 1 were evaluated by Atomic Force Microscopy (AFM) and 3D topological scans to confirm the uniformity and quality of the arrays. In brief, a Quesant Q-scope 250 (Quesant Instruments Corp., Agoura Hills, Calif.) was operated in tapping mode. Standard silicon cantilevers with a force constant of approximately 40 N/m, resonant frequency of approximately 137 kHz, and radius of curvature less than 10 nm were used. Topography and phase images were simultaneously collected at a scan rate of 2 Hz under ambient laboratory conditions. The height profiles extracted via Q-Analysis software (Quesant), and the mean height for each surface scan was calculated for subsequent statistical analysis. All significance tests were performed with SigmaStat.

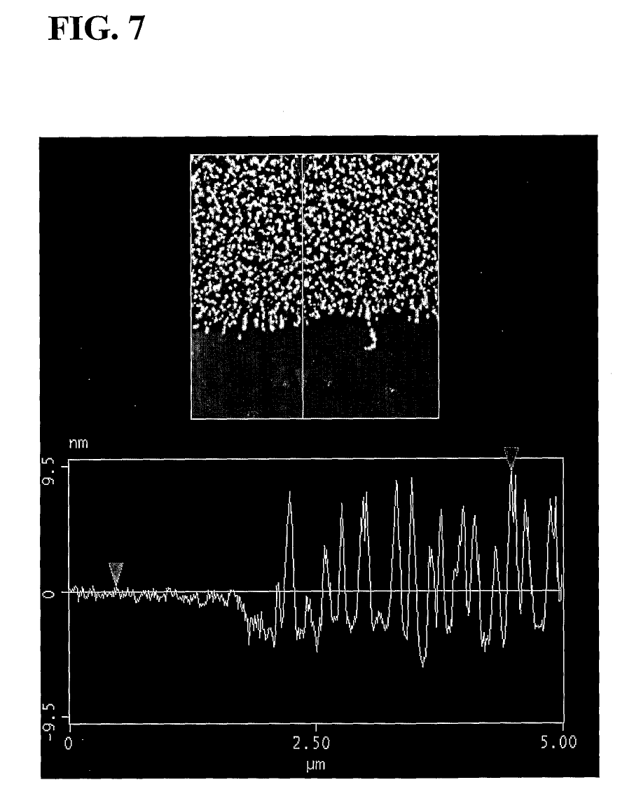

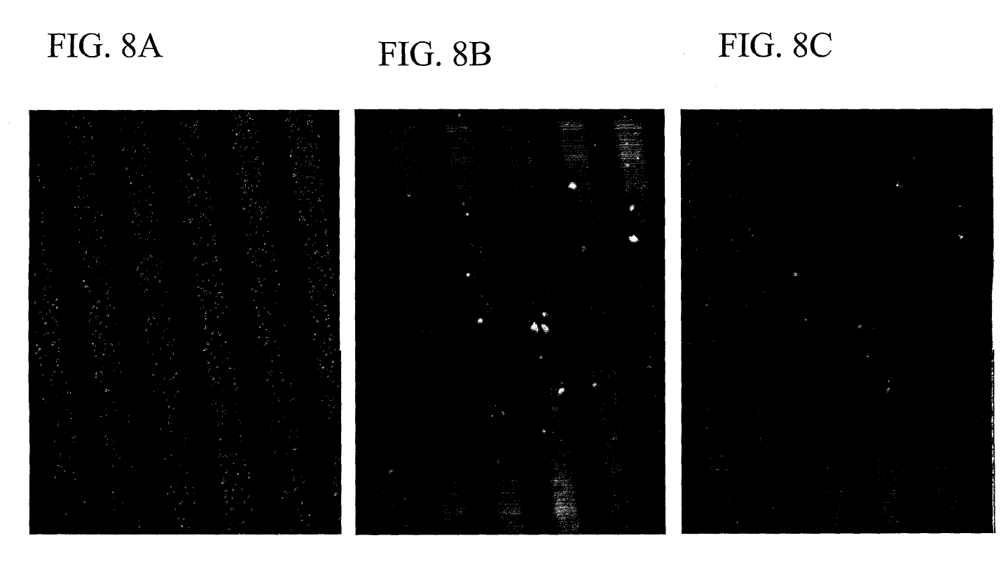

AFM amplitude and 3D topological scans of quantum dots containing covalently bound streptavidin molecules showed that the average height of these nanoparticles range between 6-8 nm (FIGS. 7A-C, FIG. 8). These values were confirmed with high resolution transmission electron microscope (TEM) measurements. These results demonstrated that contact printing onto glass slides resulted in a uniform monolayer of quantum dots in a patterned array.

### Example 3

### Molecular Binding to Contact Printed Quantum Dot Arrays

This example demonstrates that nanoparticle arrays can be used to capture and position targets of interest in a spatially organized manner. Quantum dot arrays were fabricated by contact-printing onto glass and silanized glass surfaces as described above using streptavidin-conjugated QDs. The resulting arrays were blocked with 1% BSA for 20 minutes, rinsed with PBS (×3), then dried under N₂ flow. A solution of biotinylated-QDs (0.xx-1 nM, 655 nm) was applied to the arrays, incubated for 30 minutes, rinsed in PBS, and then dried under N₂ flow. The QD arrays were examined microscopically under fluorescence to look for colorimetric overlap. As shown in FIG. 8, biotinylated QDs were captured and maintained in a defined positions corresponding to the printed streptavidin-conjugated QDs. FIG. 8A shows streptavidin-QDs printed on the surface of a glass microscope slide. FIG. 8B shows the spatial arrangement of biotinylated QDs. FIG. 8C illustrates the overlap between streptavidin- and biotin-conjugated QDs. A precise colocalization was observed between the streptavidin- and biotin-conjugated QDs. These results demonstrated that arrayed nanoparticles with specific binding molecules effectively capture and retain their targets.

### Example 4

### Biomolecules Bound to Quantum Dots Selectively Adhere to Neural Cell Receptors

This example illustrates binding of cells to quantum dots to which a specific binding molecule is attached. Quantum dots to which a β-Nerve growth factor (NGF) peptide was conjugated via a steptavidin-biotin linkage were found to bind with high density to TrkA receptors on the surface of neural PC12 cells. Recombinant mouse NGF (1156-NG/CF, R&DSystems) was biotinylated via carboxyl group substitution following procedures modified from Rosenberg et al. NGF (100 μM, 100 ug in 74 μl PBS) was diluted 1:10 with 10 mM pyridine-HCL at pH 4.8 (Aldrich). Biotin hydrazide (Sigma) (10 μmol/ml in 1 DMSO:1H2O) was added at a molar ratio of 2000 biotins per NGF subunit. The coupling agent, 1-ethyl-3-(3-dimethylaminopropoyl)-carbodiimide (EDAC, Sigma) was added to this solution at a molar ratio of 2000 EDAC per NGF and the resulting solution was incubated overnight at 23° C. This solution was supplemented with BSA and cytochrome C (Sigma) (1 mg/ml each), ultrafiltered (Centricon MWCO 3 kD, Millipore), and transferred to PBS. An excess molar ratio of 2000 EDAC:1 NGF and 2000 biotin:1 NGF is expected to biotinylate all NGF molecules and result in 3 or less biotins per NGF. NGF-QD complexes were formed by gentle vortexing and 30 mins of incubation of biotinylated ®NGF with red (655 nm) QDs containing an outer shell of covalently bound streptavidin (1012-1, Quantum Dot Corp) at 1 NGF:1 QD. Based on Quantum Dot Corp's estimates of 5-10 streptavidins/QD, it is expected that a biotinylated NGF:QD of 1:1 would bind all available biotinylated NGF.

PC12 cells (ATCC CRL-1721, ATCC) were grown in RPMI-1640 supplemented with 10% HS and 5% FBS at 37° C. For short-term receptor binding and uptake studies, cells (5×105/well) were seeded in collagen coated poly-d-lysine glass bottom culture dishes (MatTek). Cells were incubated with NGF-QD solution (10, 30, 60, and 100 nM in DMEM). Controls were performed in parallel studies at the same concentrations using streptavidin-QDs. Cells were allowed to incubate in test and control solutions for 1 hour at 37° C., washed with DMEM (×2), fixed with 4-10% paraformaldehyde (15-20 mins), and mounted in glycerol for imaging. In longer-term neurite induction studies, cells were seeded (5×10⁴ cells/well) in custom-constructed polystyrene-walled wells containing NGF-QD (3 nM and 30 nM in RPMI). Controls were done in parallel studies using: 3 nM and 30 nM biotinylated ®NGF; 3 nM and 30 nM streptavidin-QD; 0.3 nM ®NGF in RPMI. Cells were exposed to test and control solutions for 3-5 days before fixation and image analysis.

NGF-QD-treated PC12 cells and controls were imaged with an Olympus BX-DSU spinning disk confocal microscope (Olympus, USA). All samples were examined using a 60× oil immersion objective lens (Plan Apochromat NA 1.4) or 60× water immersion (LUMPLANFL NA 0.9) objective lens. Quantum dots were imaged using a 75 W xenon-arc lamp with an Olympus Filter cube (DSUMRFPHQ-ex: 535-555 nm, em: 570-620 nm) and a Hamamatsu ORCA high resolution, deep cooled monochrome CCD camera (Hamamatsu, Japan). Serial optical sections were taken using 0.5 μm optical slices and the DSU-Disk #3. Care was taken to collect test and control samples under equal exposure periods for suitable comparison. All image acquisition, processing and analysis were done using SlideBook software (v. 4.0, Intelligent Imaging Innovations, Denver, Colo.).

PC-12 cells were found to bind to NGF-QDs with high affinity. This binding of NGF-QD is specific: under the same experimental and image-acquisition conditions, quantum dots that were coated with streptavidin, a non-specific control molecule, showed a lack of significant adherence in these cells. NGF-QD binding was highly specific to cells expressing TrkA receptors, which specifically bind NGF. Cells appeared healthy and exhibited extensive neurite branching in long term assays. A confocal projection showed dense punctate fluorescence of NGF-QDs that bound to PC12 cell surfaces after 4.5 days in culture. Lack of background fluorescence indicated highly specific binding. These results demonstrate that biomolecules (such as proteins that specifically bind to receptors) can be attached onto QDs and used to specifically bind to select antigens on the surfaces of neurons.

In view of the many possible embodiments to which the principles of the disclosed invention can be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A nanoparticle array comprising:
a substrate; and
a plurality of identifiable nanoparticle probes attached to the substrate, the identifiable nanoparticle probes comprising at least one specific binding molecule for binding a target biomolecule, wherein the identifiable nanoparticle probe provides an indication of the identity of the specific binding molecule or a target bound by the specific binding molecule.

2. The nanoparticle array of claim 1, comprising sets of different nanoparticle probes, wherein different sets of nanoparticle probes comprise different specific binding molecules.

3. The nanoparticle array of claim 2, wherein the different specific binding molecules are associated with different target biomolecules.

4. The nanoparticle array of claim 3, wherein the different target biomolecules are expressed by different cells.

5. The nanoparticle array of claim 4, wherein the different cells are different subsets of neurons.

6. The nanoparticle array of claim 1, wherein the identifiable nanoparticle probes are semiconductor nanocrystal probes that emit detectable electromagnetic signals that provide the indication of the identity of the specific binding molecule.

7. The nanoparticle array of claim 6, wherein the detectable electromagnetic signals are light.

8. The nanoparticle array of claim 7, wherein the different specific binding molecules are indicated by different colors of light.

9. The nanoparticle array of claim 1, wherein the nanoparticle probes are attached to the substrate with a cleavable bond that can be selectively cleaved in response to a trigger event.

10. The nanoparticle array of claim 1, wherein the nanoparticle probes are attached to the substrate via an attachment antibody.

11. The nanoparticle array of claim 1, wherein the specific binding molecule comprises an antibody with binding affinity for the target biomolecule.

12. The nanoparticle array of claim 11, wherein the target biomolecule is an antigen associated with a target cell.

13. The nanoparticle array of claim 1, wherein the nanoparticle probes are attached to the substrates at addressable locations.

14. A device for binding biological targets, comprising:
a nanoparticle array comprising
a substrate;
a plurality of nanoparticle probes comprising semiconductor crystal nanosphere probes attached to the substrate, the nanosphere probes having a characteristic emissions fluorescence; and
specific binding molecules attached to the nanosphere probes for binding a specific target biomolecule to the nanosphere probes.

15. The device of claim 14, wherein the plurality of nanosphere probes are present in a layer of nanosphere probes on the substrate, and the nanospheres probes are present in a sufficient density to bind a cell to the nanosphere probes.

16. The device of claim 15, wherein the layer of nanosphere probes on the substrate occupies a location on the substrate that is identifiable by fluorescence emitted by the nanosphere probes.

17. The device of claim 16, further comprising multiple sets of nanosphere probes at different locations on the substrate, wherein different sets of nanosphere probes bind the same target biomolecules, and the different locations are identifiable by characteristic fluorescence emitted by the nanosphere probes.

18. The device of claim 16, further comprising multiple sets of different nanosphere probes at different locations on the substrate, wherein different sets of nanosphere probes bind different target biomolecules, and the different locations are identifiable by characteristic fluorescence emitted by the nanosphere probes.

19. The device of claim 14, wherein the target biomolecules are present on target cells to be bound to the specific binding molecules.

20. The device of claim 14, wherein the plurality of nanosphere probes are attached to the substrate by an antibody that binds to the substrate.

21. The device of claim 20, wherein the substrate comprises collagen, the antibody that binds the substrate is a biotinylated anti-collagen antibody, and streptavidin is bound to the nanosphere probes, such that the streptavidin is bound by the biotinylated antibody that binds the collagen of the substrate.

22. The device of claim 21, wherein the specific binding molecules attached to the nanosphere probes for binding a specific target biomolecule to the nanosphere probes comprise antibodies that specifically bind the target biomolecule.

23. A method of selectively binding biological targets to a substrate,
exposing the nanoparticle array of claim 1 to a biological sample to allow any of the target biomolecule in the sample to bind to the specific binding molecule.

24. The method of claim 23, wherein the target biomolecule is on a cell, and binding of the specific binding molecule to the target biomolecule binds the cell to the nanoparticle probes.

25. The method of claim 23, wherein the nanoparticle probe is a semiconductor crystal nanosphere that provides an electromagnetic signal that identifies the probe, and the method further comprises locating the bound biological target by the electromagnetic signal.

26. The method of claim 25, wherein the electromagnetic signal that identifies the probe comprises characteristic fluorescence emitted by the nanosphere.

27. The method of claim 25, wherein locating the bound biological target comprises exposing the nanosphere to an electromagnetic radiation trigger that induces emission of the electromagnetic signal that identifies the probe.

28. The method of claim 27, wherein the biological sample contains cells, and the target biomolecule is associated with a cell such that the cell binds to the nanosphere.

29. The method of claim 28, wherein multiple cells bind to the plurality of nanospheres to collect a target cell population.

30. The method of claim 29, wherein the target cell population is neuronal cells.

31. The method of claim 30, wherein the target cell population comprises cells that are bound by a specific binding molecule having specific binding affinity for rhodopsin, a GABA receptor, or glial fibrillary acidic protein.

32. The method of claim 28, wherein the specific binding molecules are attached to the nanospheres by linkers that are selectively lysable, and the method further comprises selectively lysing the linkers to selectively release the cells bound by the nanospheres.

33. A method of making the substrate of claim 1, comprising:
applying the nanoparticle probes to a template formed to present raised application surfaces that correspond to areas of the substrate to which the nanoparticle probes are to be applied; and
applying the template to the substrate to transfer the nanoparticle probes to the substrate in a pattern that corresponds to the raised application surfaces of the template.

34. The method of claim 33, wherein the raised application surfaces of the template form an ordered array, and applying the template to the substrate transfers the nanoparticle probes to the substrate in a corresponding ordered array on the surface of the substrate.

35. The method of claim 33, further comprising functionalizing the surface of the substrate prior to applying the template to the substrate to improve adherence of the nanoparticle probes to the substrate.
